(19) United States
(12) Patent Application Publication
(10) Pub. No.: US 2025/0301367 A1
(43) Pub. Date: Sep. 25, 2025

(54) METHOD AND APPARATUS FOR PERFORMING RETRANSMISSION IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/073,264

(22) Filed: Mar. 7, 2025

(30) Foreign Application Priority Data
Mar. 22, 2024 (KR) 1020240039621

(51) Int. Cl. H04W 28/06; H04L 1/18; H04W 48/18

(52) U.S. Cl. CPC H04W 28/06; H04L 1/18; H04W 48/18

(57) ABSTRACT

A method and apparatus to support enhanced retransmission is provided. Method for supporting enhanced retransmission includes receiving from a base station a Radio Resource Control (RRC) message, wherein the RRC message comprises a parameter indicating a remaining time threshold related to a radio bearer and a parameter indicating a maximum retransmission number for a Radio Link Control (RLC) entity that is associated with the radio bearer, and performing retransmission of a specific RLC Service Data Unit (SDU) in case that at least one byte of the specific RLC SDU has been transmitted and remaining time of a Packet Data Convergence Protocol (PDCP) SDU associated the specific RLC SDU becomes less than the remaining time threshold.

### CROSS-REFERENCE TO RELATED APPLICATION

This application claims priority to and the benefit of Korean Patent Application No. 10-2024-0039621, filed on Mar. 22, 2024, the disclosure of which is hereby incorporated herein by reference in its entirety.

### BACKGROUND

### Technical Field

The present disclosure relates to performing retransmission in mobile wireless communication system.

### Related Art

To meet the increasing demand for wireless data traffic since the commercialization of 4th generation (4G) communication systems, the 5th generation (5G) system is being developed. For the sake of high, 5G system introduced millimeter wave (mmW) frequency bands (e.g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

Extended Reality (XR) refers to all real-and-virtual combined environments and human-machine interactions generated by computer technology and wearables. XR is an umbrella term for different types of realities.

During a XR service, huge amount of Data Bursts may be generated and transmitted over NR downlink and uplink. Data Burst of XR services often have stringent delay budget. It requires more sophisticated uplink scheduling technique to achieve timely scheduling and to avoid excessive resource waste.

### SUMMARY

Aspects of the present disclosure are to enhance retransmission efficiency. The method includes receiving from a base station a Radio Resource Control (RRC) message, wherein the RRC message comprises a parameter indicating a remaining time threshold related to a radio bearer and a parameter indicating a maximum retransmission number for a Radio Link Control (RLC) entity that is associated with the radio bearer, and performing retransmission of a specific RLC Service Data Unit (SDU) in case that at least one byte of the specific RLC SDU has been transmitted and remaining time of a Packet Data Convergence Protocol (PDCP) SDU associated the specific RLC SDU becomes less than the remaining time threshold.

### BRIEF DESCRIPTION OF THE DRAWINGS

FIG. 1 is a diagram illustrating the architecture of an 5G system and a NG-RAN to which the disclosure may be applied.

FIG. 2 is a diagram illustrating a wireless protocol architecture in an 5G system to which the disclosure may be applied.

FIG. 3 is a diagram illustrating an RRC state transition.

FIG. 4 illustrates operation of the wireless device and network.

FIG. 5 illustrates the operation of the UE regarding PLMN selection and cell selection and cell reselection.

FIG. 6 illustrates RRC connection establishment procedure.

FIG. 7 illustrates UE capability transfer procedure.

FIG. 8 illustrates RRC connection reconfiguration procedure.

FIG. 9 illustrates data transfer procedure in RRC_CONNECTED state.

FIG. 10 illustrates RRC connection release procedure.

FIG. 11 illustrates RRC connection resumption procedure.

FIG. 12 illustrates random access procedure.

FIG. 13 illustrates scheduling request procedure based on dedicate scheduling request resource.

FIG. 14 illustrates buffer status reporting procedure.

FIG. 15 illustrates C-DRX operation.

FIG. 16 illustrates PDCP operation.

FIG. 17 illustrates RLC operation.

FIG. 18 illustrates Delay Status Report format.

FIG. 19 illustrates PDCP data PDU formats.

FIG. 20 illustrates signaling sequence to configure enhance ARQ operation.

FIG. 21 illustrates normal AM operation of AM RLC entity.

FIG. 22 illustrates retransmission operation.

FIG. 23 illustrates STATUS PDU format.

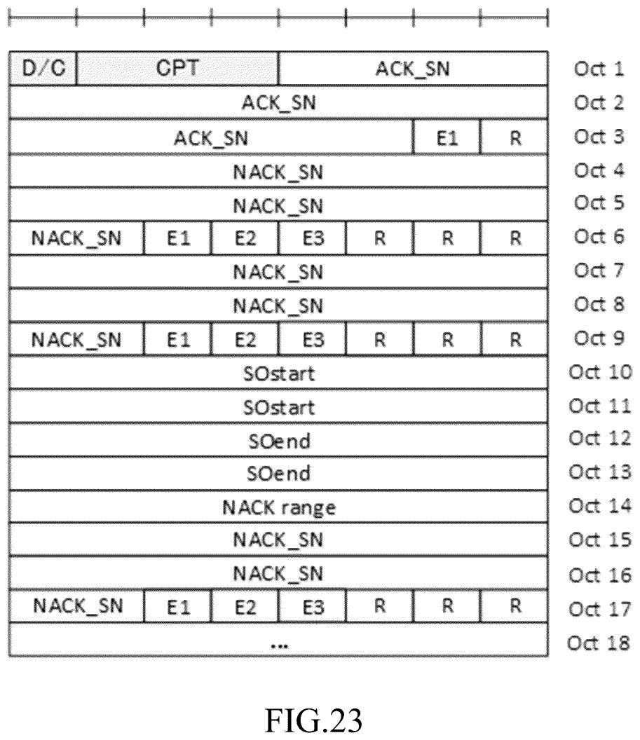

FIG. 24 illustrates AMD PDU formats.

FIG. 25 is a diagram illustrating UE operation.

FIG. 26 is a block diagram illustrating the internal structure of a Terminal to which the disclosure is applied.

FIG. 27 is a block diagram illustrating the configuration of a base station according to the disclosure.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

Followings can be used interchangeably depending on given context:
PDCP SDU and PDCP PDU;
PDCP Data PDU and PDCP PDU and RLC SDU;
RLC SDU and RLC PDU and AMD PDU;
The transmitting side of the AM RLC entity and UE;
The transmitting side of the AM RLC entity and base station;
The receiving side of the AM RLC entity and UE;
The receiving side of the AM RLC entity and base station;

In the present disclosure, UE and terminal and wireless device can be used interchangeably. In the present disclosure, NG-RAN node and base station and GNB can be used interchangeably.

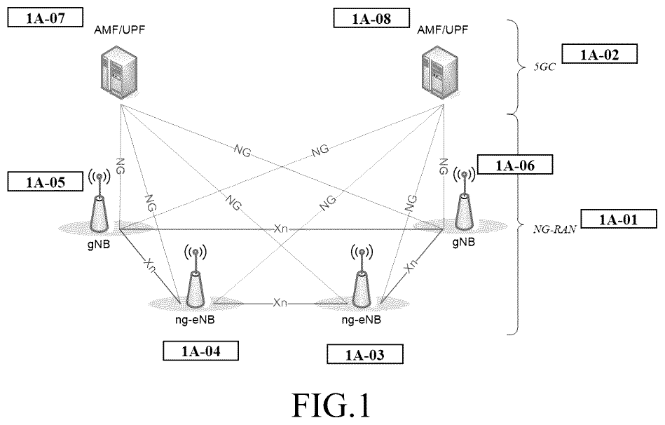

FIG. 1 is a diagram illustrating the architecture of an 5G system and a NG-RAN to which the disclosure may be applied.

5G system consists of NG-RAN 1A-01 and 5GC 1A-02. An NG-RAN node is either:
a gNB, providing NR user plane and control plane protocol terminations towards the UE; or
an ng-eNB, providing E-UTRA user plane and control plane protocol terminations towards the UE.

The gNBs 1A-05 or 1A-06 and ng-eNBs 1A-03 or 1A-04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A-07 and UPF 1A-08 may be realized as a physical node or as separate physical nodes.

A gNB 1A-05 or 1A-06 or an ng-eNBs 1A-03 or 1A-04 hosts the various functions listed below.
Functions for Radio Resource Management such as Radio Bearer Control, Radio Admission Control, Connection Mobility Control, Dynamic allocation of resources to UEs in uplink, downlink and sidelink (scheduling); and
IP and Ethernet header compression, uplink data decompression and encryption of user data stream; and
Selection of an AMF at UE attachment when no routing to an MME can be determined from the information provided by the UE; and
Routing of User Plane data towards UPF; and
Scheduling and transmission of paging messages; and
Scheduling and transmission of broadcast information (originated from the AMF or O&M); and
Measurement and measurement reporting configuration for mobility and scheduling; and
Session Management; and
QoS Flow management and mapping to data radio bearers; and
Support of UEs in RRC_INACTIVE state; and

The AMF 1A-07 hosts the functions such as NAS signaling, NAS signaling security, AS security control, SMF selection, Authentication, Mobility management and positioning management.

The UPF 1A-08 hosts the functions such as packet routing and forwarding, transport level packet marking in the uplink, QoS handling and the downlink, mobility anchoring for mobility etc.

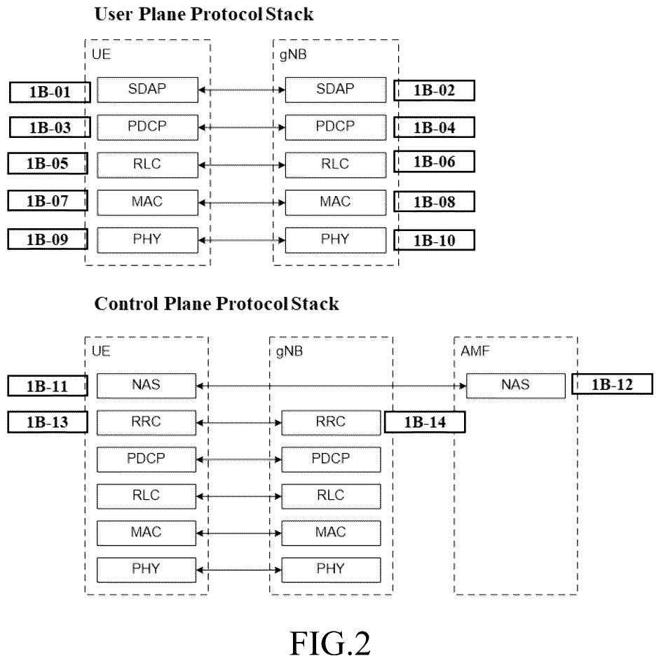

FIG. 2 is a diagram illustrating a wireless protocol architecture in an 5G system to which the disclosure may be applied.

User plane protocol stack consists of SDAP 1B-01 or 1B-02, PDCP 1B-03 or 1B-04, RLC 1B-05 or 1B-06, MAC 1B-07 or 1B-08 and PHY 1B-09 or 1B-10. Control plane protocol stack consists of NAS 1B-11 or 1B-12, RRC 1B-13 or 1B-14, PDCP, RLC, MAC and PHY.

Each protocol sublayer performs functions related to the operations listed below.
NAS: authentication, mobility management, security control etc.
RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.
SDAP: Mapping between a QoS flow and a data radio bearer, Marking QoS flow ID (QFI) in both DL and UL packets.
PDCP: Transfer of data, Header compression and decompression, Ciphering and deciphering, Integrity protection and integrity verification, Duplication, Reordering and in-order delivery, Out-of-order delivery etc.
RLC: Transfer of upper layer PDUs, Error Correction through ARQ, Segmentation and re-segmentation of RLC SDUs, Reassembly of SDU, RLC re-establishment etc.
MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.
PHY: Channel coding, Physical-layer hybrid-ARQ processing, Rate matching, Scrambling, Modulation, Layer mapping, Downlink Control Information, Uplink Control Information etc.

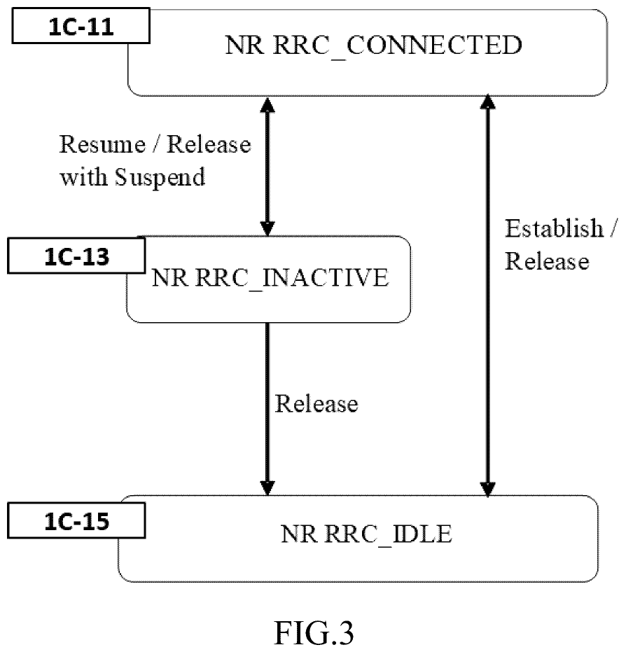

FIG. 3 is a diagram illustrating an RRC state transition.

Between RRC_CONNECTED 1C-11 and RRC_INACTIVE 1C-13, a state transition occurs by the exchange of the Resume message and the Release message containing the Suspend IE.

A state transition occurs between RRC_CONNECTED 1C-11 and RRC_IDLE 1C-15 through RRC connection establishment and RRC connection release.

The UE supports three RRC states.

In RRC_IDLE, UE has no RRC connection with RAN. The UE monitors paging channel and idle mode mobility (UE based mobility). As name implies, in RRC_IDLE state, data transmission/reception is not possible and power consumption is minimal. To perform data transfer, UE is required to transition to RRC_CONNECTED state.

In RRC_CONNECTED, UE has valid RRC connection with RAN. The UE establishes radio bearer configured for data transmission/reception. UE mobility is handled by network-controlled handover. RRC_CONNECTED state is most power-consuming state. To minimize power consumption during this state, C-DRX and other technique can be applied.

In RRC_INACTIVE, UE has suspended RRC connection with RAN. Before performing full scale data transfer, the UE and the base station resume the suspended RRC connection. UE mobility is handled by idle mode mobility within RAN defined area. If UE is capable of and configured by the base station, data transfer in limited scale can be performed in RRC_INACTIVE state, which is called small data transmission procedure.

RRC_IDLE state can be characterized with followings:
PLMN selection; Broadcast of system information;
Cell re-selection mobility;
Paging for mobile terminated data is initiated by 5GC;
DRX for CN paging configured by NAS.

RRC_INACTIVE state can be characterized with followings:
PLMN selection; Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC-NG-RAN connection (both C/U-planes) is established for UE;
The UE AS context is stored in NG-RAN and the UE;
NG-RAN knows the RNA which the UE belongs to.

RRC_CONNECTED state can be characterized with followings:
5GC-NG-RAN connection (both C/U-planes) is established for UE;
The UE AS context is stored in NG-RAN and the UE;
NG-RAN knows the cell which the UE belongs to;
Transfer of unicast data to/from the UE;
Network controlled mobility including measurements.

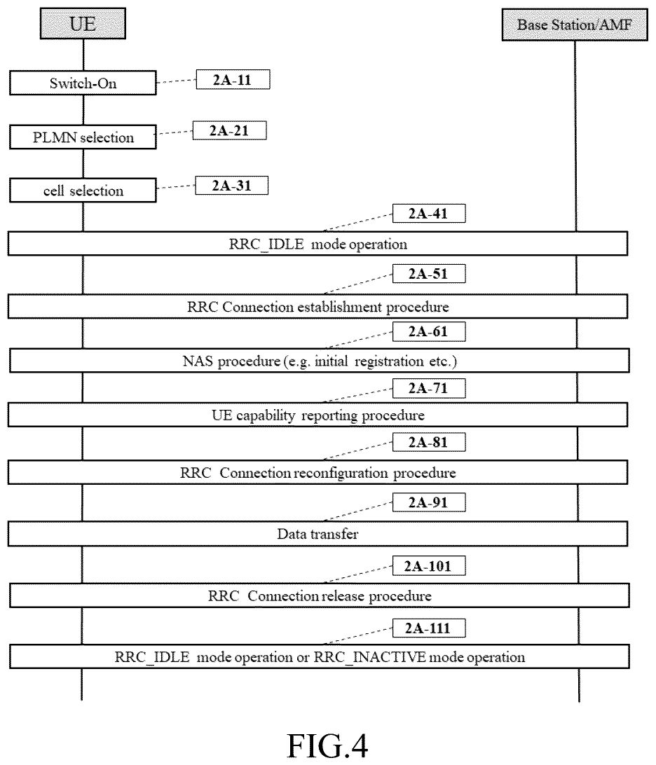

FIG. 4 illustrates operation of the wireless device and network.

Upon switch-on of the wireless device (e.g. UE) 2A-11, UE performs PLMN selection 2A-21 to select the carrier that is provided by the PLMN that UE is allowed to register.

Then UE performs cell selection 2A-31 to camp on a suitable cell.

Once camping on a suitable cell, UE performs RRC_IDLE mode operation 2A-41 such as paging channel monitoring and cell reselection and system information acquisition.

UE performs RRC Connection establishment procedure 2A-51 to perform e.g. NAS procedure such as initial registration with the selected PLMN.

After successful RRC connection establishment, UE performs NAS procedure 2A-61 by transmitting a corresponding NAS message via the established RRC connection (e.g. SRB1).

The base station can trigger UE capability reporting procedure 2A-71 before configuring data bearers and various MAC functions.

The base station and the UE perform RRC connection reconfiguration procedure 2A-81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A-91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A-101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A-111 until the next event to RRC connection establishment/resumption occurs.

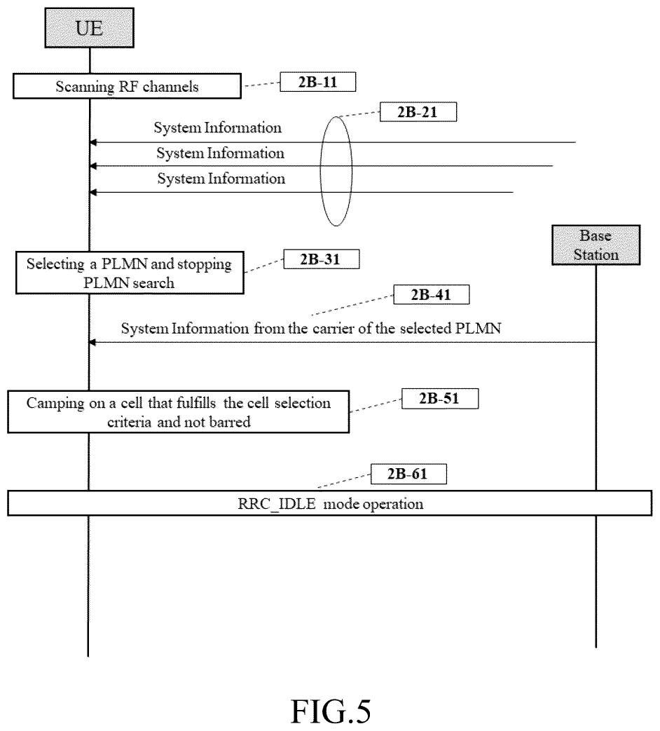

FIG. 5 illustrates the operation of the UE regarding PLMN selection and cell selection and cell reselection.

For PLMN selection, the UE may scan all RF channels to find available PLMNs 2B-11. On each carrier, the UE shall search for the strongest cell and read its system information 2B-21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B-31.

Once the UE has selected a PLMN, the cell selection procedure shall be performed in order to select a suitable cell of that PLMN to camp on.

The UE performs measurement on detectable cells and receives system information from whichever detectable cells that system information is readable 2B-41.

The UE consider cell selection criterion S is fulfilled when:
Srxlev>0 AND Squal>0
where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B-51.

The UE camps on the selected cell. The UE perform RRC_IDLE mode operation 2B-61 such as monitoring control channels to receive system information and paging and notification message.

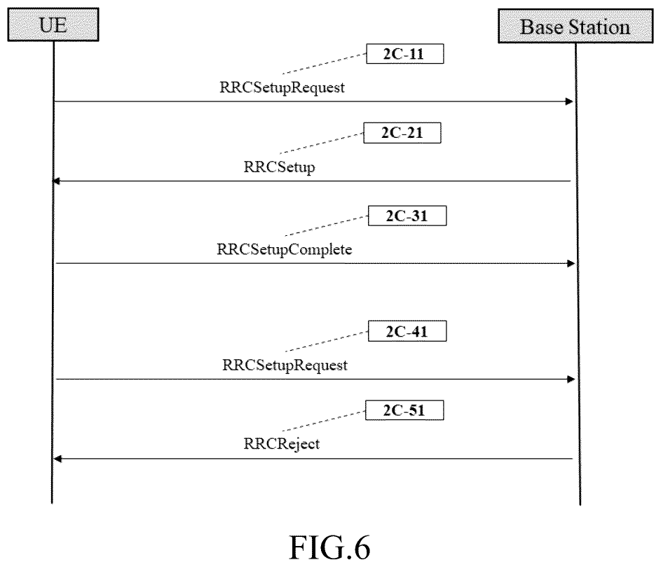

FIG. 6 illustrates RRC connection establishment procedure.

Successful RRC connection establishment procedure comprises:
transmission of RRCSetupRequest by the UE 2C-11;
reception of RRCSetup by the UE 2C-21;
transmission of RRCSetupComplete by the UE 2C-31.

Unsuccessful RRC connection establishment procedure comprises:
transmission of RRCSetupRequest by the UE 2C-41;
reception of RRCReject by the UE 2C-51;

RRCSetupRequest comprises following fields and IEs:
ue-Identity field contains InitialUE-Identity IE which contains:
ng-5G-S-TMSI-Part1 field containing a BIT STRING of 39 bit;
establishmentCause field contains EstablishmentCause IE which contains:
2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup comprises following fields and IEs:
radioBearerConFIG. field containing a RadioBearerConFIG. IE;
masterCellGroup field containing a CellGroupConFIG. IE.

RRCSetupComplete comprises following fields and IEs:
selectedPLMN-Identity field containing an integer indicating selected PLMN;
dedicatedNAS-Message field containing a DedicatedNAS-Message which may contain various NAS message;
ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identify the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
perform the cell group configuration procedure in accordance with the received masterCellGroup;
perform the radio bearer configuration procedure in accordance with the received radioBearerConfig;
if stored, discard the cell reselection priority information provided by the cellReselectionPriorities or inherited from another RAT;
enter RRC_CONNECTED;
stop the cell re-selection procedure;
consider the current cell to be the PCell;

The UE transmits to the base station RRCSetupComplete after performing above actions.

The UE sets the contents of RRCSetupComplete message as follows:
set the ng-5G-S-TMSI-Value to ng-5G-S-TMSI-Part2;
set the selectedPLMN-Identity to the PLMN selected by upper layers from the plmn-IdentityInfoList;
include the s-NSSAI-List and set the content to the values provided by the upper layers;

For network to configure the UE with appropriate configurations, the network needs to know the capability of the UE. For this end, the UE and the base station perform UE capability transfer procedure.

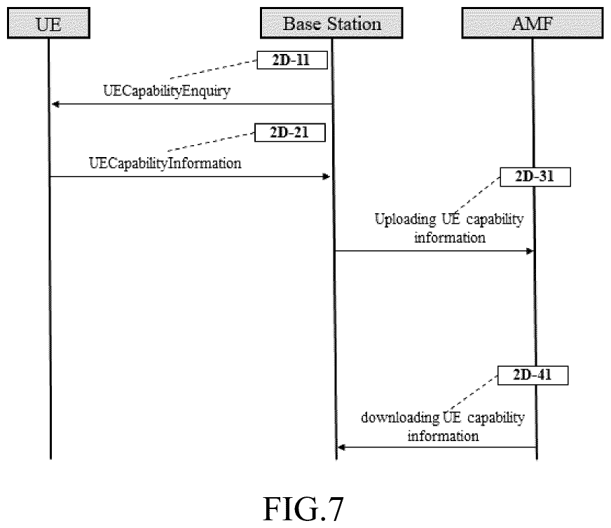

FIG. 7 illustrates UE capability transfer procedure.

UE capability transfer procedure consists of exchanging UECapabilityEnquiry 2D-11 and UECapabilityInformation 2D-21 between the UE and the base station.

In the UECapabiliityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2D-31. When UE capability information is needed afterward, AMF provide it to the base station 2D-41.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

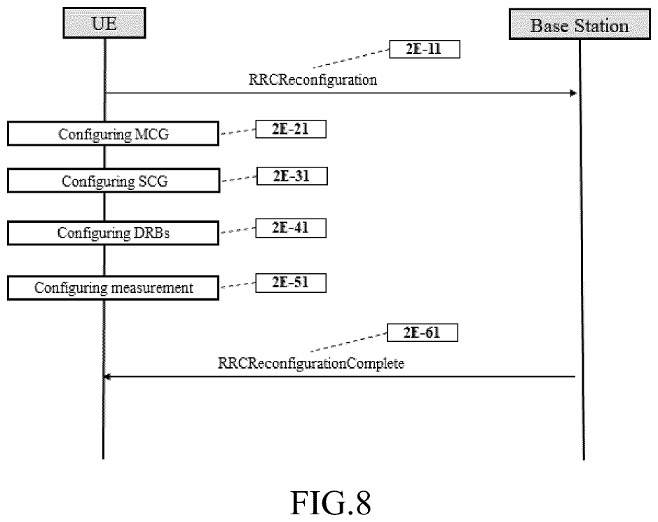

FIG. 8 illustrates RRC connection reconfiguration procedure.

RRC reconfiguration procedure consists of exchanging RRCReconfiguration 2E-11 and RRCReconfigurationComplete 2E-61 between the base station and the UE.

RRCReconfiguration may comprises following fields and IEs:
rrc-TransactionIdentifier field contains a RRC-TransactionIdentifier IE;
radioBearerConFIG. field contains a RadioBearerConFIG. IE;
   radioBearerConFIG. field comprises configuration information for SRBs and DRBs via which RRC messages and user traffic are transmitted and received;
secondaryCellGroup field contains a CellGroupConFIG. IE;
   secondaryCellGroup field comprises configuration information for secondary cell group;
   A cell group consists of a SpCell and zero or more SCells;
   Cell group configuration information comprises cell configuration information for SpCell/SCell and configuration information for MAC and configuration information for logical channel etc;
measConFIG. field contains a MeasConFIG. IE;
   measConFIG. field comprises configuration information for measurements that the UE is required to perform for mobility and other reasons.
masterCellGroup field contains a CellGroupConFIG. IE;

Upon reception of RRCReconfiguration, UE processes the IEs in the order as below. UE may:
perform the cell group configuration for MCG based on the received masterCellGroup 2E-21;
perform the cell group configuration for SCG based on the received secondaryCellGroup 2E-31;
perform the radio bearer configuration based on the received radioBearerConFIG. 2E-41;
perform the measurement configuration based on the received measConFIG. 2E-51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

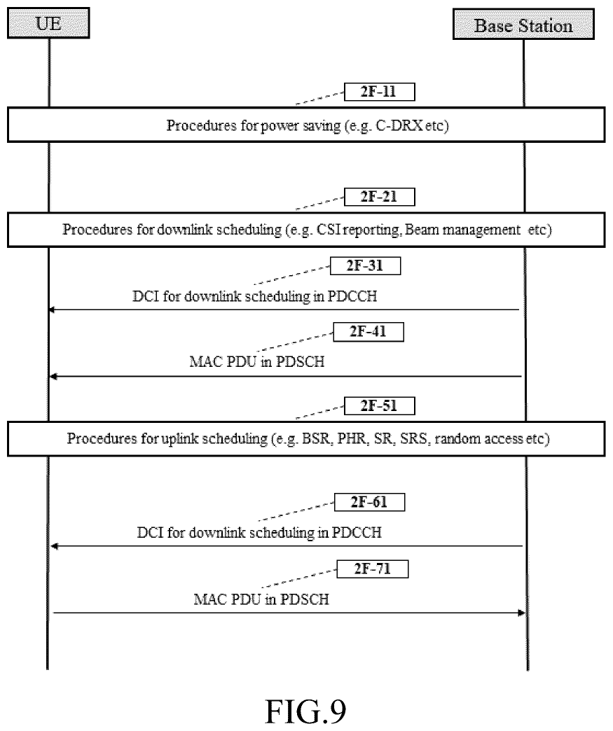

FIG. 9 illustrates data transfer procedure in RRC_CONNECTED state.

The UE and the base station may perform procedures for power saving such as C-DRX 2F-11. The configuration information for C-DRX is provided to the UE within cell group configuration in the RRCReconfiguration.

The UE and the base station may perform various procedures for downlink scheduling 2F-21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F-31. The base station transmits to the UE PDSCH corresponding to the DCI and containing a MAC PDU 2F-41.

The UE and the base station may perform various procedure for uplink scheduling 2F-51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F-61. The base station transmits to the UE PDSCH corresponding to the DCI and containing a MAC PDU 2F-71.

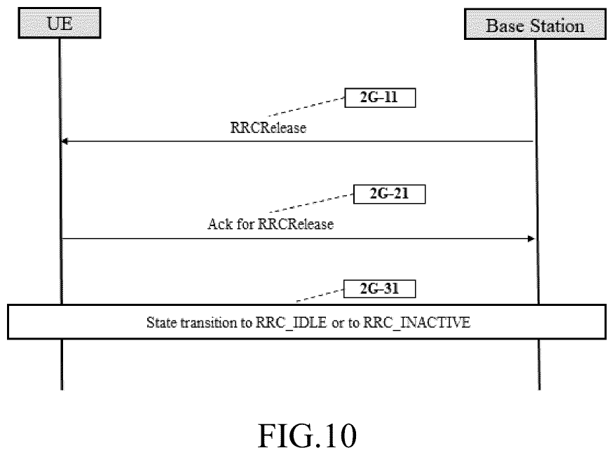

FIG. 10 illustrates RRC connection release procedure.

RRC connection release procedure comprises:
transmission of RRCRelease from the base station to the UE 2G-11; and
transmission of acknowledgement for the RRCRelease from the UE to the base station 2G-21; and
state transition from RRC_CONNECTED to either RRC_IDLE or RRC_INACTIVE 2G-31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may comprise following fields for redirection:
redirectedCarrierInfo field comprises RedirectedCarrierInfo IE;
   RedirectedCarrierInfo IE comprises either CarrierInfoNR IE or RedirectedCarrierInfo-EUTRA IE;
      CarrierInfoNR IE comprises ARFCN-ValueNR IE and SubcarrierSpacing IE;

The UE may perform cell selection on the carrier indicated by CarrierInfoNR IE or RedirectedCarrierInfo-EUTRA IE.

The RRCRelease may comprise following fields to configure cell reselection priority:
cellReselectionPriorities field comprises CellReselectionPriorities IE;
   CellReselectionPriorities IE comprises:
      FreqPriorityListNR IE;
      t320 field indicates a timer value for cell reselection priority validity;

During idle mode mobility, the UE applies the CellReselectionPriorities until T320 expires or stops.

The RRCRelease may comprises following fields/IEs to transition UE to RRC_INACTIVE state:
suspendConFIG. field comprises SuspendConFIG. IE;
   fullI-RNTI field comprises I-RNTI-Value IE;
   shortI-RNTI field comprises ShortI-RNTI-Value IE;
   ran-PagingCycle field comprises PagingCycle IE;
   ran-NotificationAreaInfofield comprises RAN-NotificationAreaInfo IE;
   t380 field comprises PeriodicRNAU-TimerValue;
   nextHopChainingCount field comprises NextHopChainingCount IE.
   ran-ExtendedPagingCycle field comprises ExtendedPagingCycle IE.

To transit the UE to RRC_INACTIVE, the base station includes SuspendConFIG. IE in the RRCRelease. To transit the UE to RRC_IDLE, the base station does not include SuspendConFIG. IE in the RRCRelease.

Upon reception of RRCRelease, UE may:
delay the actions caused by RRCRelease 60 ms from the moment the RRCRelease message was received or optionally when lower layers indicate that the receipt of the RRCRelease message has been successfully acknowledged, whichever is earlier;
store the cell reselection priority information provided by the cellReselectionPriorities and start T320;
if the RRCRelease includes suspendConfig:
   reset MAC and release the default MAC Cell Group configuration;
   apply the received suspendConFIG. except the received nextHopChainingCount;
   if the sdt-ConFIG. is configured:
      for each of the DRB in the sdt-DRB-List, consider the DRB to be configured for SDT;
      if sdt-SRB2-Indication is configured, consider the SRB2 to be configured for SDT;
      re-establish the RLC entity for each RLC bearer that is not suspended;
      trigger the PDCP entity to perform SDU discard for SRB1 and SRB2;
      if sdt-MAC-PHY-CG-ConFIG. is configured, configure the PCell with the configured grant resources for SDT and start the cg-SDT-TimeAlignmentTimer;
   3: if srs-PosRRC-Inactive is configured, apply the configuration and instruct MAC to start the inactivePosSRS-TimeAlignmentTimer;
   re-establish RLC entities for SRB1;
   stop the timer T319 if running;
   store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within Reconfiguration WithSync of the NR PSCell (if configured) and all other parameters configured except for:
      parameters within ReconfigurationWithSync of the PCell;
      parameters within Reconfiguration WithSync of the NR PSCell, if configured;
      parameters within MobilityControlInfoSCG of the E-UTRA PSCell, if configured;
      servingCellConfigCommonSIB;
   suspend all SRB(s) and DRB(s) and multicast MRB(s), except SRB0 and broadcast MRBs;
   indicate PDCP suspend to lower layers of all DRBs and multicast MRBs;
   start timer T380, with the timer value set to t380;
   indicate the suspension of the RRC connection to upper layers;
   2: enter RRC_INACTIVE and perform cell selection;
else (if the RRCRelease does not include suspendConfig):
   perform the actions upon going to RRC_IDLE;

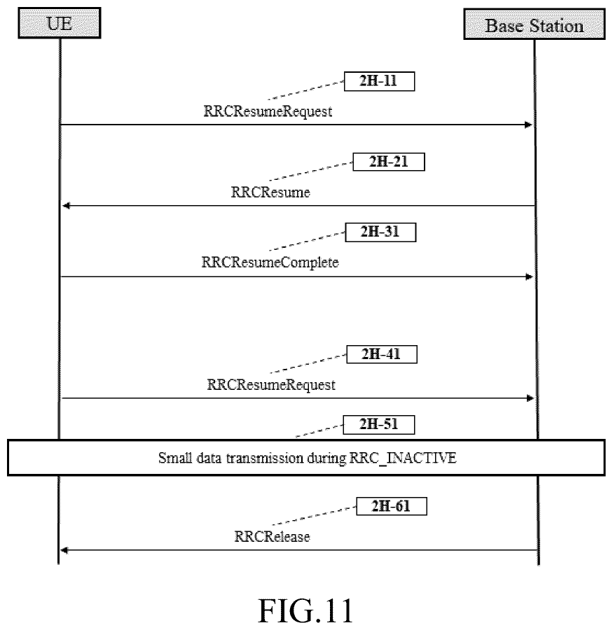

FIG. 11 illustrates RRC connection resumption procedure.

RRC connection resume procedure, in case of state transition from RRC_INACTIVE to RRC_CONNECTED, consists of RRC message exchange between the UE and the base station: RRCResumeRequest 2H-11 and RRCResume 2H-21 and RRCResumeComplete 2H-31.

RRC connection resume procedure, in case of small data transmission without state transition, consists of RRC message exchange between the UE and the base station: RRCResumeRequest 2H-41 and RRCRelease 2H-51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for transmission of RRCResumeRequest). Then UE transmits RRCResumeRequest 2H-11 or 2H-41 to the base station. The message comprises the UE identifier which can be used by the base station to identify the UE context where RRC connection information of the UE is stored.

When the base station determines that UE needs to be in RRC_CONNECTED state, the base station transmits RRCResume. Upon reception of RRCResume 2H-21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2H-51. When the base station determines that small data transmission is finished, the base station transmits RRCRelease 2H-61.

Random access procedure enables the UE to align uplink transmission timing, and indicate the best downlink beam, and transmit a MAC PDU that may contain CCCH SDU (e.g. RRCSetupRequest).

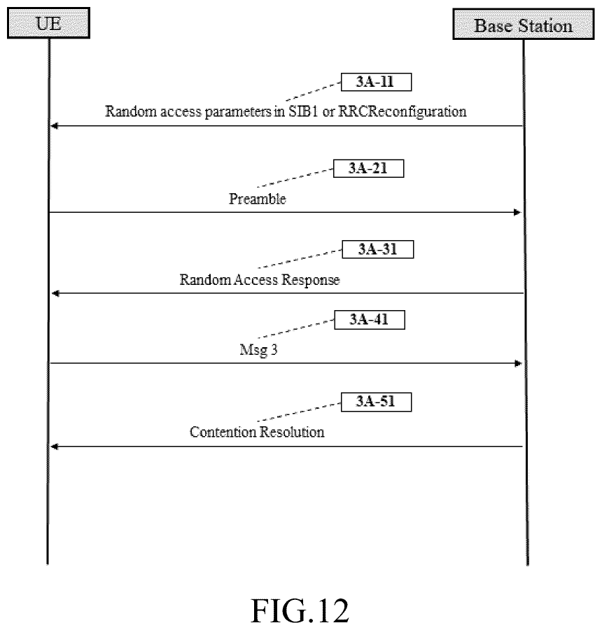

FIG. 12 illustrates random access procedure.

Random access procedure comprises preamble transmission 3A-21, random access response reception 3A-31, Msg 3 transmission 3A-41 and contention resolution 3A-51.

Parameters for random access procedure are provided in SIB1 (in case of initial access) or in RRCReconfiguration (in case of handover) 3A-11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
flush the buffer for Msg 3;
initialize the counters for preamble transmission and power ramping;
select the uplink carrier for performing the random access procedure based on a rsrp threshold (e.g. rsrp-ThresholdSSB-SUL);
select the set of Random Access resources applicable to the current Random Access procedure;
select a SSB based on a rsrp threshold (e.g. rsrp-ThresholdSSB); a SSB corresponds to a downlink beam;
select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
select a random access preamble randomly with equal probability from the random access preambles associated with the selected SSB and the selected random access preamble group;
determine the next available PRACH occasion from the PRACH occasions corresponding to the selected SSB;
determine the transmission power of the preamble;

$$>> : preamble transmission power = pathloss + preambleReceivedTargetPower + DELTA\_PREAMBLE + ( PREAMBLE\_POWER \_RAMPING \_COUNTER - 1 ) \times PREAMBLE\_POWER \_STEP + POWER\_OFFSET \_ 2 STEP\_RA$$

transmit the preamble in the determined PRACH occasion with the determined transmission power;
1; start ra-Response Window;
monitor the PDCCH of the SpCell for Random Access Response(s) identified by the RA-RNTI while the ra-Response Window is running;
receive Random Access Response contains a MAC subPDU with Random Access Preamble identifier corresponding to the transmitted preamble;
process the received Timing Advanced Command and the received UL grant;
transmit a Msg 3 based on the received UL grant;
   Msg 3 may contain e.g. CCCH SDU such as RRCSetupRequest or RRCResumeRequest;
start ra-ContentionResolutionTimer;
monitor the PDCCH while the ra-ContentionResolutionTimer is running;
consider Contention Resolution successful when MAC PDU containing a UE Contention Resolution Identity MAC CE is received;
consider the Random Access procedure successfully completed.

Unlink downlink traffic, the scheduler in the base station does not know when UE needs to be scheduled for uplink transmission. To enable uplink scheduling, the UE can be configured with scheduling request resource. When uplink resource is required for the UE, the UE can transmit a one-bit signal on the scheduling request resource based on the scheduling request procedure.

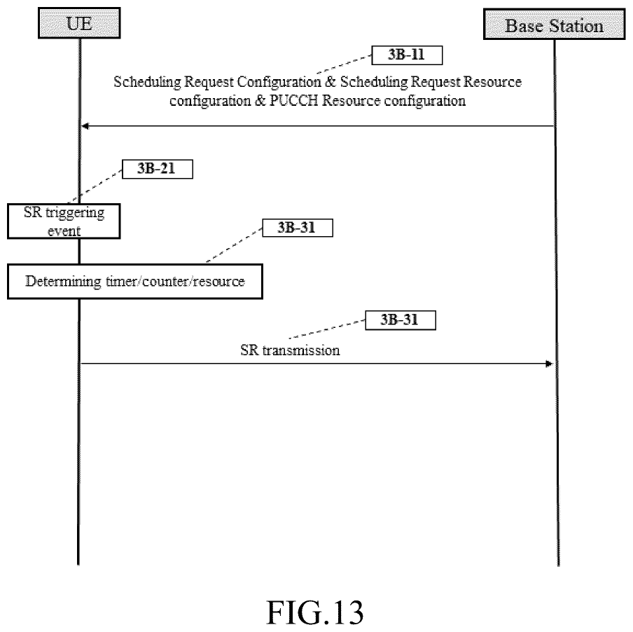

FIG. 13 illustrates scheduling request procedure based on dedicate scheduling request resource.

The base station provides to the UE configuration information for dedicate scheduling request procedure in RRCReconfiguration 3B-11.

The configuration information comprises four main components: mapping information between events and the counter/timer/time resource/frequency resource, configuration information for counter/timer, configuration information for time resource, and configuration information for frequency resource.

One or more instances of configuration information on counter/timer (e.g. SchedulingRequestToAddMod) can be provided to the UE; each of them is associated with an identifier (e.g. schedulingRequestId). An initial value for counter (e.g. sr-TransMax) defines the number of consecutive times for SR transmission that is allowed. The timer (sr-Prohibittimer) defines the minimum time duration between the consecutive SR transmission.

One or more instances of configuration information on scheduling request resource (e.g. SchedulingRequestResourceConfig) can be provided to the UE; each of them is associated with an identifier (schedulingRequestID). The configuration information further comprises time domain information for the resource (e.g. periodicityAndOffset) and the identifier of the associated timer/counter (schedulingRequestResourceId) and the identifier of the associated frequency domain resource (PUCCH-ResourceId).

One or more instances of configuration information on PUCCH resource (e.g. PUCCH-Resource) can be provided to the UE; each of them is associated with an identifier (e.g. PUCCH-ResourceId). The configuration information comprises identifier of PRB where the PUCCH resource starts and an indication whether intra-slot frequency hopping is enabled.

The base station can indicate UE which counter/timer shall be used for which SR triggering event by binding the SR triggering event with a schedulingRequestId.

SR triggering event can be: data arrival in logical channel, SCell beam failure recovery, positioning measurement gap activation/deactivation request etc.

When an SR triggering event occurs 3B-21, the UE determines the associated counter/timer based on the mapping information between SR triggering event and schedulingRequestId. Based on the determined schedulingRequestID, the UE determines the associated PUCCH-Resource and the associated SchedulingRequestResource 3B-31; more specifically, the UE determines that the SchedulingRequestResource of which configuration information comprises schedulingRequestID is the SchedulingRequestResource associated with the timer/counter identified by the schedulingRequestID.

The UE transmits the SR:
in the time/frequency resource determined from SchedulingRequestResource associated with the schedulingRequestId; and
based on the prohibit timer and the initial counter value determined from the schedulingRequestId.

SchedulingRequestToAddMod and SchedulingRequestResource have one to one relationship between them.

Unlink downlink traffic, the scheduler in the base station does not know when and how much and how important data arrives in the UE. To provide information on buffer status, the UE may transmit a Buffer Status Report (BSR) MAC CE when deemed triggered. BSR MAC CE comprises one or more Buffer Size field, each of which indicates the amount of data available for transmission across logical channels of a logical channel group.

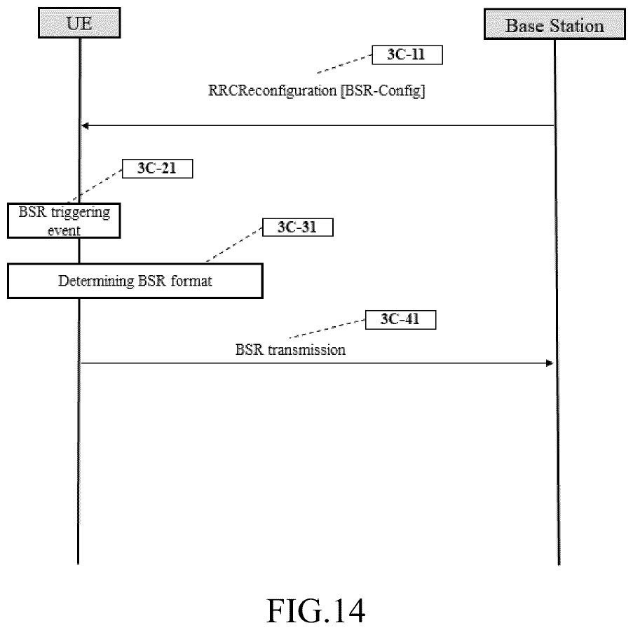

FIG. 14 illustrates buffer status reporting procedure.

The base station provides a BSR configuration via a dedicate RRC message such as RRCReconfiguration 3C-11. The BSR configuration comprises a timer controlling periodic reporting and other information. The mapping information between a logical channel and a logical channel group is also provided in the dedicate RRC message.

BSR can be triggered event-driven or periodically or based on padding. Upon a significant event that cause buffer status change or upon expiry of a timer or upon space for padding being available, BSR is triggered 3C-21.

The UE determines the format of the BSR depending on which event triggers the BSR 3C-31.

Based on the number of logical channel groups with data available for transmission, a short format and a long format are defined.

Based on whether all logical channels can be reported or not, a truncated format and the normal/full format are defined.

Short BSR and Short Truncated BSR comprise following fields:
LCG ID field indicates the identifier of LCG whose buffer status is being reported.
short Buffer Size field indicates the total amount of data available across all logical channels of a logical channel group. The amount of data is indicated in number of bytes. The length of this field is 5 bit.

Long BSR and Long Truncated BSR comprises following fields:
Bitmap field comprises 8 bit. Each bit indicates the presence of the Buffer Size field for the corresponding logical channel group;
long Buffer Size field indicates the total amount of data available across all logical channels of a logical channel group. The amount of data is indicated in number of bytes. The length of this field is 8 bit.

In principle, since the information contained in BSR triggered due to new uplink data or timer expiry is crucial for uplink scheduling, BSR format is determined solely based on the number of LCGs for reporting. On the other hands, the information contained in BSR triggered due to padding is supplementary information for uplink scheduling, BSR format is determined based on the number of LCGs and the size of padding space.

The UE transmits a Short BSR in the following case:
only one LCG has data available for transmission and the BSR is triggered due to new uplink data or timer expiry; or
1 only one LCG has data available for transmission and the size of padding is enough to accommodate the Short BSR.

The UE transmits a Short Truncated BSR in the following case:
padding occurs (e.g. MAC SDUs or MAC CEs do not fill up all the available space of MAC PDU); and
more than one LCG have data available for transmission; and
the size of padding is not enough to accommodate a Long BSR or a Long Truncated BSR but enough to accommodate the Short Truncated BSR.

The UE transmits a Long BSR in the following case:
more than one LCGs have data available for transmission and the BSR is triggered due to new uplink data or timer expiry.

The UE transmits a Long Truncated BSR in the following case:
padding occurs; and
more than one LCG have data available for transmission; and
the size of padding is not enough to accommodate a Long BSR but enough to a Long Truncated BSR.

The UE transmits BSR 3C-41. To get the uplink resource for BSR transmission, if the BSR is triggered for new uplink data that is important than what are stored previously, scheduling request procedure can be initiated beforehand.

For power saving of UE in RRC_CONNECTED, C-DRX can be configured by the base station.

During C-DRX operation, UE monitors PDCCH discontinuously so that power consumption is reduced during when UE does not monitor PDCCH.

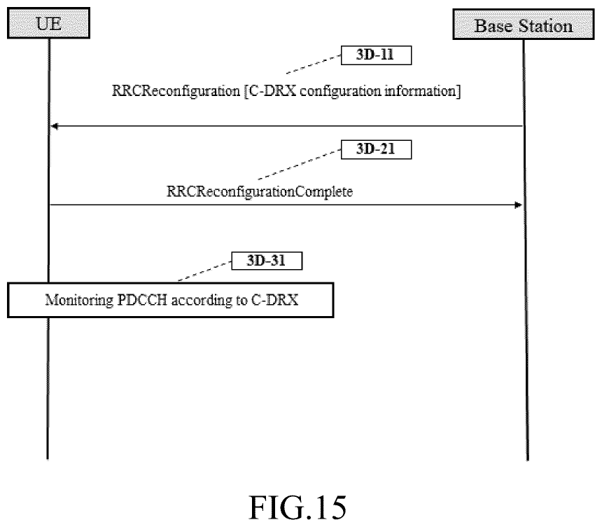

FIG. 15 illustrates C-DRX operation.

To enable C-DRX for the UE, the base station transmits to the UE RRCReconfiguration comprising C-DRX configuration information 3D-11. C-DRX configuration information comprises various timer values and offsets that define the starting point of and the length of active periods.

C-DRX configuration information comprises: drx-onDurationTimer field, drx-InactivityTimer field, drx-HARQ-RTT-TimerDL field, drx-HARQ-RTT-TimerUL field, drx-RetransmissionTimerDL field, drx-RetransmissionTimerUL field, drx-LongCycleStartOffset field, drx-ShortCycle field and drx-ShortCycleTimer field.

Upon reception of C-DRX configuration for a DRX group, UE enables C-DRX for the DRX group (consisting of one or more serving cells of the UE). After then, UE transmits to the base station RRCReconfigurationComplete 3D-21.

When C-DRX is configured and enabled, UE monitors PDCCH during Active Time and UE does not monitor PDCCH outside of Active Time 3D-31.

Active Time for serving cells in a DRX group includes the time while:
drx-onDurationTimer or drx-InactivityTimer configured for the DRX group is running; or
drx-RetransmissionTimerDL, drx-Retransmission TimerUL or drx-RetransmissionTimerSL is running on any Serving Cell in the DRX group; or
ra-ContentionResolutionTimer (as described in clause 5.1.5) or msgB-Response Window (as described in clause 5.1.4a) is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity.
drx-onDurationTimer periodically starts. The starting time and the periodicity of the drx-onDurationTimer are determined based on drx-LongCycleStartOffset and drx-ShortCycle. The purpose of drx-onDurationTimer is to provide stable scheduling opportunities during C-DRX operation.
drx-InactivityTimer starts and restarts upon specific events such as reception of PDCCH indicating new transmission. The purpose of drx-InactivityTimer is to extend Active Time for further scheduling.

For quick adaptation of Active Time, drx-onDurationTimer and drx-InactivityTimer stop when a specific MAC CE (e.g. DRX Command MAC CE is received).
drx-Retransmission TimerDL and drx-RetransmissionTimerUL and drx-RetransmissionTimerSL are used for providing scheduling opportunities for HARQ retransmission. Those timers start after transmission of initial transmission or reception of initial transmission or transmission of retransmission or reception of retransmission.

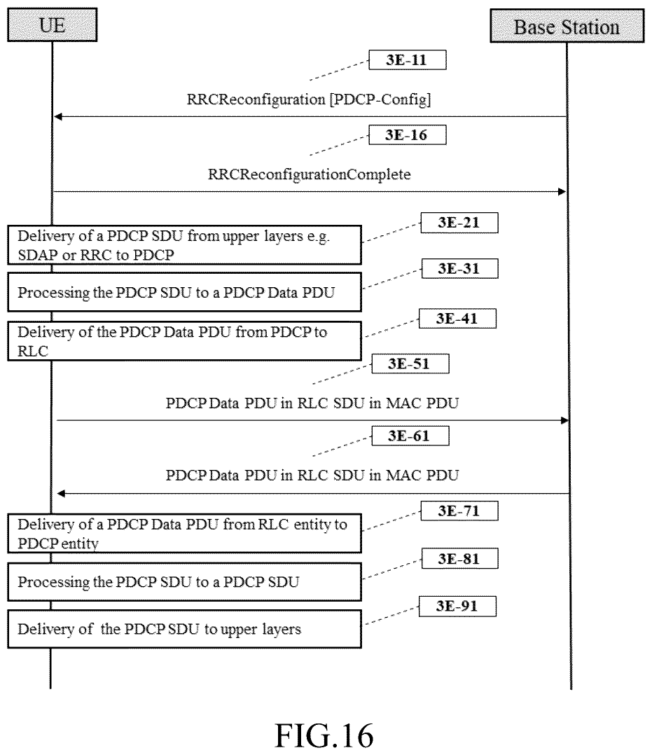

FIG. 16 illustrates PDCP operation.

PDCP performs followings for a DRB or a SRB.
Transfer of data (user plane or control plane);
Header compression and decompression;
Ciphering and deciphering;
Integrity protection and integrity verification;

To configure PDCP entity for a radio bearer, the base station transmits to the UE RRCReconfiguration comprising PDCP configuration information 3E-11. PDCP configuration information comprises parameters for e.g. PDCP SN size, header compression, status reporting, discard timer and reordering timer etc.

UE configures the PDCP entity accordingly and transmits RRCReconfigurationComplete 3E-16.

### PDCP Transmission Operation

When upper layer delivers a PDCP SDU to the PDCP entity 3E-21, PDCP entity processes the PDCP SDU to a PDCP Data PDU by applying header compression and ciphering and integrity protection 3E-31. PDCP entity then delivers the PDCP Data PDU to the RLC entity of the RLC bearer serving the radio bearer 3E-41.

UE transmits the PDCP Data PDU in a RLC SDU in a MAC PDU 3E-51.

### PDCP Reception Operation

UE receives a MAC PDU containing a RLC SDU containing a PDCP Data PDU 3E-61. RLC entity the PDCP Data PDU to the PDCP 3E-71, then PDCP process the PDCP Data PDU to a PDCP SDU by applying integrity verification, deciphering and header decompression 3E-81. PDCP deliver the PDCP SDU to the upper layer 3E-91.

RLC supports three transmission modes: Transparent Mode (TM); Unacknowledged Mode (UM); and Acknowledged Mode (AM).

RLC performs followings for a RLC bearer.
Transfer of PDCP PDUs;
Automatic Retransmission request operation (AM only);
Segmentation (AM and UM) and re-segmentation (AM only) of RLC SDUs;
Reassembly of SDU (AM and UM);

A RLC bearer is assocated with a radio bearer.

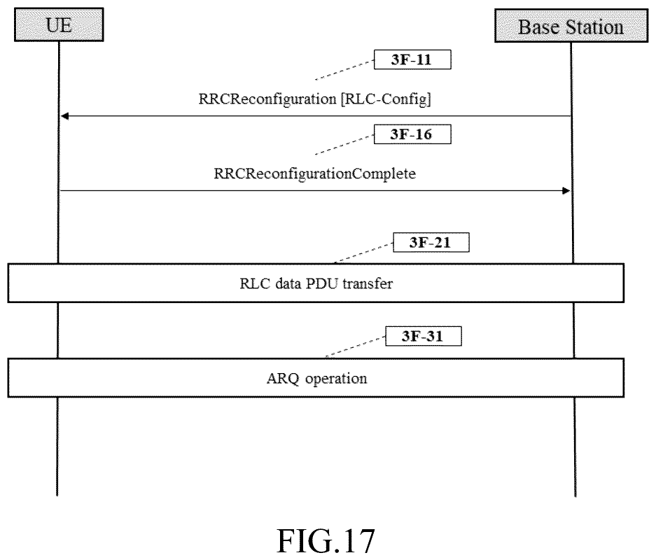

FIG. 17 illustrates RLC operation.

To configure RLC entity for a RLC bearer, the base station transmits to the UE RRCReconfiguration comprising RLC configuration information 3F-11. RLC configuration information comprises parameters for e,g, RLC SN size, various timers related to status reporting, various timers related to reassembly etc.

UE configures the RLC entity accordingly and transmits RRCReconfigurationComplete 3F-16.

Transmitting side of RLC entity (either in UE or in Base Station) and receiving side of RLC entity (either in Base station or in UE) performs RLC data PDU transfer 3F-21. Transmitting side of RLC entity processes a RLC SDU into a RLC data PDU by segmenting (if necessary) the RLC SDU and attaching RLC header. The RLC data PDU is transmitted to the receiving side of RLC entity. Receiving side of RLC entity processes the RLC data PDU to the RLC SDU by reassembling RLC data PDUs (if necessary) and detaching RLC header.

Transmitting side of RLC entity (either in UE or in Base Station) and receiving side of RLC entity (either in Base station or in UE) performs ARQ operation 3F-31. Receiving side of RLC entity transmit to the transmitting side of RLC entity STATU PDU that acknowledges positively or negatively reception status of RLC SDUs. Transmitting side of RLC entity performs retransmission of the RLC SDUs that are negatively acknowledged.

RLC AM is designed to ensure reliability over the air interface. RLC AM design focuses on how to achieve ultra high reliability and good radio efficiency. RLC AM does not allow blind retransmission and does not allow frequent feedback. Combining those two facts results in poor retransmission delay.

XR traffic with stringent requirements both on delay and jitter need to have short and stable retransmission delay. Otherwise, a single packet in the retransmission buffer may degrade the overall QoS significantly.

In addition, data transfer in NR air interface is performed across multiple layers. To achieve transmission efficiency, cross layer operation between PDCP and RLC is required. For example, RLC should not retransmit a packet that is determined useless in PDCP layer.

Retransmission in RLC AM is based on RLC STATUS REPORT. Upon detecting missing packet or upon reception of polling bit, RLC Rx entity constructs a STATUS REPORT that contains overall reception status of RLC SDUs (hereinafter, RLC SDU refers to both RLC SDU and RLC SDU segments). RLC Tx entity, upon receiving the STATUS REPORT, retransmits the NACKed RLC SDU and discards ACKed RLC SDUs. To avoid frequent STATUS REPORT transmission, a timer called t-StatusProhibit starts when STATUS REPORT is transmitted. Subsequent STATUS REPORT transmission is allowed only after the timer expires.

Above operations work well for TCP traffics. However, to carter for XR traffic new operation that enables faster retransmission is required.

The enhancement can be summarized as below:
GNB configures DRBs serving XR traffic to operate in delay-sensitive mode and DRBs serving non-XR traffic to operate in normal mode;
GNB and UE perform enhanced AM operation and normal AM operation.

Table below summarizes the normal mode AM operation and delay-sensitive mode AM operation

TABLE 1

| Normal mode AM operation | Delay-sensitive mode AM operation |
|---|---|
| Polling trigger | Polling trigger |
| Polling (e.g. including a poll in the AMD PDU) | Polling (e.g. including a poll in the AMD PDU) |
| is based on: | is based on: |
| buffer status (e.g. based on empty buffer); or | buffer status (e.g. based on empty buffer); or |
| PDU_WITHOUT_POLL; or | PDU_WITHOUT_POLL; or |
| BYTE_WITHOUT_POLL. | BYTE_WITHOUT_POLL. |
| Poll bit is retransmitted upon expiry of | Indication from PDCP when remaining time |
| t-PollRetransmit. | until the discardTimer expiry is less than a |
| STATUS REPORT | first threshold. |
| Stand-alone STATUS REPORT contains ACK | Poll bit is retraansmitted upon expiry of |
| info and NACK info. | t-PollRetransmit. |
| Retransmission | Poll bit is retransmitted upon expiry of |
| Retransmission of a RLC SDU is triggered if | t-PollRetransmit2. |
| it is NACKed in the STATUS REPORT | STATUS REPORT |
| | Stnad-alone STATUS REPORT contains ACK |
| | info and NACK info. |
| | Embedded STATUS REPORT contains ACK |
| | info. |
| | Retransmission |
| | Retransmission of a RLC SDU is triggered if |
| | it is NACKed in the STATUS REPORT |
| | Retransmission of a RLC SDU is triggered |
| | if it not ACKed in the embedded STATUS |
| | REPORT |

Possible solutions are explained below.

### Delay-Aware Polling

### Overview

Polling (e.g. including a poll in the AMD PDU; setting P bit to 1 in the AMD PDU) is based on buffer status (e.g. when the transmission buffer and retransmission buffer will be empty after transmission of a AMD PDU) or transmission status (e.g. when poll has not be included in AMD PDU for specific number of AMD PDUs or specific amount of bytes). Above ensure that polling is triggered regularly and at the end of data burst.

For XR traffic where delay requirement is stringent, data should be successfully delivered before the data becomes useless.

The delay is controlled by discardTimer in PDCP. When a XR data is transmitted and successful delivery of the XR data is not confirmed yet, transmitting entity needs to know whether the data has to be retransmitted or has been successfully delivered before the data becomes useless. It can be known based on STATUS REPORT which is triggered by polling.

When RLC is operating in delay-sensitive mode RLC AM, RLC triggers polling, in addition to other polling triggers, when PDCP requests RLC delivery status of a RLC SDU waiting for acknowledgement. The overall timeline of PDCP operations and RLC operations are as below.

A PDCP SDU arrives at PDCP; PDCP starts discardTimer.

The PDCP SDU is mapped with a PDCP COUNT and processed to PDCP PDU (ciphering/integrity protection, header compression etc).

The PDCP PDU is submitted to RLC entity (that is configured with delay-sensitive mode).

RLC entity generates AMD PDU from the PDCP PDU.

RLC entity submitted the AMD PDU to the MAC entity that transmits the AMD PDU. PDCP indicates the RLC entity when remaining time of the discardTimer is smaller than a first threshold.

RLC trigger polling to trigger STATUS REPORT from the peer RLC.

RLC entity retransmit the AMD PDU when STAUT REPORT with negative acknowledgement of the RLC SDU is received.

RLC entity inform PDCP successful delivery of RLC SDU/PDCP PDU when STATUS REPORT with acknowledgement of the RLC SDU is received.

PDCP entity indicates MAC when remaining time of the discardTimer is smaller than a second threshold.

MAC entity triggers DSR MAC CE upon receiving indication from the PDCP.

### RRC Signaling

GNB may configure UE with one or more DRBs. Each DRB serves one or more QoS flows. PDCP configuration of each DRB is indicated PDCP-Config IE in RadioBearerConfig IE. Each DRB is served by one or two RLC entities. RLC configuration associated with each DRB is indicated in RLC-Config IE in RLC-BearerConfig in CellGrouopConfig.

To configure an AM bearer, GNB includes UL-AM-RLC IE and DL-AM-RLC IE in RLC-Config IE.

If the AM bearer is to operate in normal mode, GNB configures following fields in UL-AM-RLC IE and DL-AM-RLC IE.

| | |
|---|---|
| UL-AM-RLC ::= | SEQUENCE { |
| sn-FieldLength | SN-FieldLengthAM |
| t-PollRetransmit | T-PollRetransmit, |
| pollPDU | PollPDU, |
| pollByte | PollByte, |
| maxRetxThreshold | ENUMERATED { t1, t2, t3, t4, t6, t8, |
| t16, t32 } | |
| DL-AM-RLC ::= | SEQUENCE { |
| sn-FieldLength | SN-FieldLengthAM |
| t-Reassembly | T-Reassembly, |
| t-StatusProhibit | T-StatusProhibit |
| PollPDU ::= | ENUMERATED |
| | p4, p8, p16, p32, p64, p128, p256, |

p512, p1024, p2048, p4096, p6144, p8192, p12288, p16384,p20480,
p24576, p28672, p32768, p40960, p49152, p57344, p65536, infinity, spare8, spare7,
spare6, spare5, spare4, spare3, spare2, spare1}

| | |
|---|---|
| PollByte ::= | ENUMERATED { |
| | kB1, kB2, kB5, kB8, kB10, kB15, |

kB25, kB50, kB75, kB100, kB125, kB250, kB375, kB500, kB750,
kB1000, kB1250, kB1500, kB2000, kB3000, kB4000,
kB4500, kB5000, kB5500, kB6000, kB6500, kB7000,
kB7500, mB8, mB9, mB10, mB11, mB12, mB13,
mB14, mB15, mB16, mB17, mB18, mB20, mB25,
mB30, mB40, infinity, spare20, spare19, spare18,
spare17, spare16, spare15, spare14, spare13, spare12,
spare11, spare10, spare9, spare8, spare7, spare6, spare5,
spare4, spare3, spare2, spare1}

| | |
|---|---|
| T-Reassembly ::= | ENUMERATED { |
| | ms0, ms5, ms10, ms15, ms20, ms25, |

ms30, ms35, ms40, ms45, ms50, ms55, ms60, ms65,
ms70, ms75, ms80, ms85, ms90, ms95, ms100,
ms110, ms120, ms130, ms140, ms150, ms160, ms170,
ms180, ms190, ms200, spare1}

| | |
|---|---|
| T-StatusProhibit ::= | ENUMERATED { |
| | ms0, ms5, ms10, ms15, ms20, ms25, |

ms30, ms35, ms40, ms45, ms50, ms55, ms60, ms65,
ms70, ms75, ms80, ms90, ms95, ms100,
ms105, ms110, ms115, ms120, ms125, ms130,
ms135, ms140, ms145, ms150, ms155, ms160,
ms165, ms170, ms175, ms180, ms185, ms190,
ms195, ms200, ms205, ms210, ms215, ms220,
ms225, ms230, ms235, ms240, ms245, ms250,
ms300, ms350, ms400, ms450, ms500, ms800,
ms1000, ms1200, ms1600, ms2000, ms2400, spare2, spare1}

| | |
|---|---|
| SN-FieldLengthUM ::= | ENUMERATED {size6, size12} |
| SN-FieldLengthAM ::= | ENUMERATED {size12, size18} |

maxRetxThreshold: Parameter for RLC AM. Value t1 corresponds to 1 retransmission, value t2 corresponds to 2 retransmissions and so on.
pollByte: Parameter for RLC AM. Value kB25 corresponds to 25 kBytes, value kB50corresponds to 50 kBytes and so on. infinity corresponds to an infinite amount of kBytes.
pollPDU: Parameter for RLC AM. Value p4 corresponds to 4 PDUs, value p8 corresponds to 8 PDUs and so on. infinity corresponds to an infinite number of PDUs.
sn-FieldLength: the RLC SN field size in bits. Value size6 means 6 bits, value size12means 12 bits, value size18 means 18 bits.
t-PollRetransmit: Timer for RLC AM in milliseconds. Value ms5 means 5 ms, value ms10 means 10 ms and so on.
t-Reassembly: Timer for reassembly in milliseconds. Value ms0 means 0 ms, value ms5 means 5 ms and so on.
t-StatusProhibit: Timer for status reporting in milliseconds. Value ms0 means 0 ms, value ms5 means 5 ms and so on.

If the AM bearer is to operate in delay-sensitive mode, GNB configures following fields in:

```
  UL-AM-RLC IE and DL-AM-RLC IE; and
  PDCP-Config IE.
```

| | |
|---|---|
| UL-AM-RLS ::= | SEQUENCE { |
| sn-FieldLength | SN-FieldLengthAM |
| t-PollRetransmit | T-PollRetransmit, |
| pollPDU | PollPDU, |
| pollByte | PollByte, |
| maxRetxThreshold | ENUMERATED { t1, t2, t3, t4, t6, t8, t16, t32 } |
| pollPDCP | ENUMERATED {enabled} OPTIONAL |

/// indicates that poll triggered by PDCP is enabled///

| | |
|---|---|
| embeddedAck | ENUMERATED {enabled} OPTIONAL |

/// indicates that one-byte embedded ACK is configured; UE shall
include embedded ACK in the UL AMD PDU///

| } | | |
|---|---|---|
| DL-AM-RLC ::= | SEQUENCE { | |
| sn-FieldLength | SN-FieldLengthAM | |
| t-Reassembly | T-Reassembly, | |
| t-StatusProhibit | T-StatusProhibit | |
| embeddedAck | ENUMERATED | {enabled} |

OPTIONAL

```
  /// indicates that one-byte embedded ACK is configured; will be
present in the DL AMD PDU///
  }
```

| | |
|---|---|
| PDCP-Config ::= | SEQUENCE { |
| drb | SEQUENCE { |
| discardTimer | ENUMERATED {ms10, ms20, ms30, ms40, |
| ms50, ms60, ms75, ms100, | |
| ... | |
| pdu-SetDiscard-r18 | ENUMERATED {true} |

```
  /// If set to true, the UE shall perform PDU set based discarding for this PDCP entity,
as specified in TS 38.323 [5].///
  ...
```

| | |
|---|---|
| remainingTimeForRlcNotification | ENUMERATED {ms10, ms20, |

```
ms30, ms40, ms50, ms60, ms75, ms100, ms150, ms200,ms250, ms300, ms500, ms750,
ms1500, infinity}
  /// PDCP Tx Entity informs RLC Tx Entity when remaining time of discardTimer is
below the indicated value. RLC Tx entity takes proper measure (e.g. trigging polling)
upon indication.///
    }
```

If pollPDCP is comprised in UL-AM-RLC IE (or if delay sensitive mode is configured), maxRetxThreshold is ignored (e.g. RRCReestablishment is not triggered even if number of retransmission exceed maxRetxThreshold).

### UE/GNB Operation

UE receives from a GNB a RRCReconfiguration message.

UE performs with GNB RLC data transfer for a DRB based on a Poll bit in AMD PDU and STATUS REPORT.

In case that:
the DRB is associated with RLC AM bearer; and
RLC-Config of the RLC AM bearer does not comprise a specific field related to RLC poll,

UE includes a poll in an AMD PDU:
if PDU_WITHOUT_POLL>=pollPDU;
if BYTE_WITHOUT_POLL>=pollByte:
if both the transmission buffer and the retransmission buffer become empty (excluding transmitted RLC SDUs or RLC SDU segments awaiting acknowledgements) after the transmission of the AMD PDU;
if no new RLC SDU can be transmitted after the transmission of the AMD PDU (e.g. due to window stalling); or
upon expiry of t-PollRetransmit.

In case that:
the DRB is associated with RLC AM bearer; and
RLC-Config of the RLC AM bearer comprises a specific field related to RLC poll, UE includes a poll in an AMD PDU:
if PDU_WITHOUT_POLL>=pollPDU;
if BYTE_WITHOUT_POLL>=pollByte:
if both the transmission buffer and the retransmission buffer become empty (excluding transmitted RLC SDUs or RLC SDU segments awaiting acknowledgements) after the transmission of the AMD PDU;
if no new RLC SDU can be transmitted after the transmission of the AMD PDU (e.g. due to window stalling);
upon expiry of t-PollRetransmit; or
if remaining time of discardTimer of a specific PDCP PDU (RLC SDU) becomes less than remainingTimeForRlcNotification, wherein the specific PDCP PDU (RLC SDU) is the RLC SDU of which at least one byte has been transmitted at least once, for which successful delivery of whole RLC SDU has not been confirmed yet.

### Polling Retransmission

### Overview

Polling retransmission mechanism is necessary to deal with the case of polling PDU being lost.

For general mechanism, a longer poll retransmission timer is used. For XR traffic, a shorter poll retransmission timer is used.

RLC starts either the long timer or the short timer upon transmitting polling PDU (e.g. AMD PDU with poll bit set to 1) depending on how poll is triggered.

### RRC Signaling

GNB configures following fields in UL-AM-RLC IE and DL-AM-RLC IE for normal bearer.
t-PollRetransmit
GNB configures following fields in UL-AM-RLC IE and DL-AM-RLC IE for delay-sensitive bearer.
t-PollRetransmit
t-PollRetransmit_1 field that comprises shorter value than t-PollRetransmit

### UE/GNB Operation

UE receives from a GNB a RRCReconfiguration message.

UE performs with GNB RLC data transfer for a DRB based on Poll bit in AMD PDU and STATUS REPORT and retransmission timers.

In case that:
the DRB is associated with RLC AM bearer; and
RLC-Config of the RLC AM bearer does not comprise a specific field related to RLC poll,

RLC includes a poll in an AMD PDU:
if PDU_WITHOUT_POLL>=pollPDU;
if BYTE_WITHOUT_POLL>=pollByte:
if both the transmission buffer and the retransmission buffer become empty (excluding transmitted RLC SDUs or RLC SDU segments awaiting acknowledgements) after the transmission of the AMD PDU;
if no new RLC SDU can be transmitted after the transmission of the AMD PDU (e.g. due to window stalling); or
upon expiry of t-PollRetransmit.

In case that:
the DRB is associated with RLC AM bearer; and
RLC-Config of the RLC AM bearer comprises a specific field related to RLC poll, RLC includes a poll in an AMD PDU:
if PDU_WITHOUT_POLL>=pollPDU;
if BYTE_WITHOUT_POLL>=pollByte:
if both the transmission buffer and the retransmission buffer become empty (excluding transmitted RLC SDUs or RLC SDU segments awaiting acknowledgements) after the transmission of the AMD PDU;
if no new RLC SDU can be transmitted after the transmission of the AMD PDU (e.g. due to window stalling);
upon expiry of t-PollRetransmit_1; or
if remaining time of discardTimer of a specific PDCP PDU (RLC SDU) becomes less than remainingTimeForRlcNotification;
   the specific PDCP PDU (RLC SDU) is the RLC SDU:
      of which at least one byte has been transmitted at least once;
      successful delivery of whole RLC SDU has not been confirmed yet.

If UE includes a poll in an AMD PDU due to that remainging time of discardTimer of a specific PDCP PDU becomes less than remainingTimeForRlcNotification,
UE includes the Poll in the AMD PDU that comprises the specific PDCP PDU; or
UE includes the poll in a specific AMD PDU. The specific AMD PDU is AMD PDU that comprises the RLC SDU corresponding to the specific PDCP PDU.

UE transmits the AMD PDU.

Upon submission of the AMD PDU including the poll that is triggered by request from the upper layer, RLC starts t-PollRetransmit_1 and set POLL_SN_1 (to SN associated with the RLS SDU that is indicated by the upper layer).

Upon submission of the AMD PDU including the poll that is triggered by PDU_WITHOUT_POLL/BYTE_WITHOUT_POLL, RLC starts t-PollRetransmit and set POLL_SN.

Upon receiving STATUS report, RLC stops t-PollRetransmit or t-PollRetransit_1 or both depending on positive acknowledgements and negative acknowledgements in the STATUS report.

Upon expiry of t-PollRetranmsit, RLC includes a poll in the AMD PDU that has not been transmitted and will be transmitted in the next transmission opportunity.

Upon expiry of t-PollRetranmsit_1, RLC includes a poll in the AMD PDU that contains the RLC SDU having triggered t-PollRetransmit_1 and transmits the AMD PDU in the next transmission opportunity.

### PDCP Operation

### Overview

To deal with delay-sensitive XR traffic properly, PDCP entity interacts with the lower layers to minimize XR traffic being useless by exceeding delay limit.

UE is configured with two thresholds: remaining TimeThreshold and remainingTimeForRlcNotification.

When remaining time of a PDCP SDU becomes less than remainingTimeForRlcNotification first time,
UE includes a Poll in the AMD PDU that is transmitted at the next transmission opportunity;
UE transmits bytes of the RLS SDU (associated with the PDCP SDU) that has not been transmitted; and
UE retransmits bytes of the RLC SDU that:
has been transmitted; and
neither positively acknowledged nor negatively acknowledged.

When remaining time of a PDCP SDU becomes less than remaining TimeThreshold first time:
UE triggers DSR MAC CE; and
UE considers the RLC SDU associated with the PDCP SDU for retransmission. remainingTimeThreshold is:
configured/indicated in MAC-CellGroupConfig;
specific for a group of PDCP entities (e.g. single value is configured for the group of PDCP entities).
remainingTimeForRlcNotification is:
configured/indicated in PDCP-Config;
specific for a PDCP entity (e.g. configured for each PDCP entity individually possibly with different values).

### Embedded STATUS Report & Standalone STATUS Report

### Overview

To reduce retransmission delay, embedded STATUS report is introduced. Embedded STATUS report is comprised in AMD PDU. Embedded STATUS report comprises ACK_SN_1 field (or ACK_SN_2 field) that contains a SN that corresponds to the value of SN of the highest/latest SN among RLC SDUs of which all bytes are received or completely received (RX_ Highest_Rcvd or RX_Latest_Rcvd). Since RX_ Highest_Rcvd may indicate the highest SN of SDU that has been sent by the transmittig entity but has not been received by the RLC receiving entity, RLC transmitting entity may perform autonomous retranmsission.

ACK_SN_1 (or ACK_SN_2) field may contain/indicate one of followings:
Rx_Highest_Rcvd: the value of the SN of the RLC SDU with the highest SN among received RLC SDUs. It is initially set to a value that will not trigger autonomous retransmission (e.g. highest SN like 2\hat{ }[sn-FieldLength]; upper edge of receiving window +1). It is updated when a RLC SDU with SN higher than current Rx Highest_Rcvd.
Rx_Latest_Rcvd: the value of the SN of the RLC SDU that has been received most recently. It is initially set to a value that will not trigger autonomous retransmission (e.g. highest SN like 2\hat{ }[sn-FieldLength]; upper edge of receiving window +1). It is updated when a RLC SDU with SN different from current Rx Latest Rcvd.
RX_Next: SN following the last in-sequence completely received RLC SDU, and it serves as the lower edge of the receiving window. It is initially set to 0, and is updated whenever the AM RLC entity receives an RLC SDU with SN=RX Next.

RX_Last_Insequence: SN of the last in-sequence completely received RLC SDU.

RLC receiving entity includes an embedded STATUS report in AMD PDU in case that the value to be indicated in the ACK_SN_1 (or ACK_SN_2) field is updated from lastest ACK_SN_1 (or ACK_SN_2) field.

RLC transmitting entity performs retransmission of RLC SDU corresponding to the RLC SN in the embedded STATUS report in case that a configured amount of time has been elapsed since the last byte of the RLC SDU was transmitted. It is to avoid unnecessary retransmission that may happen if the indicated RLC SDU is still processed in HARQ process.

In this disclosure, STATUS report and STATUS PDU are used interchangeably (and have same meaning).

GNB configures following fields for normal bearer and delay-sensitive bearer.

TABLE 2

| | Normal Bearer | Delay-sensitive bearer |
|---|---|---|
| DL-AM-RLC | sn-FieldLength | sn-FieldLength |
| IE | t-Reassembly | t-Reassembly |
| | t-StatusProhibit | t-StatusProhibit |
| | | t-StatusProhibit2 |
| | | embeddedStatusReportEnabled |
| UL-AM-RLC | sn-FieldLength | sn-FieldLength |
| IE | maxRetxThreshold | t-retransmission |
| | | embeddedStatusReportEnabled |

t-StatusProhibit2: indicates timer for embedded STATUS report. RLC receiving entity triggers embedded STATUS report when this timer is not running.
embeddedStatusReportEnabled in DL-AM-RLC IE: indicates that embedded STATUS report reception associated functions are enabled (e.g. reconstructing RLC SN from received embedded STATUS report and performing retransmission based on embedded STATUS report etc). t-StatusProhibit2 may implicitly indicate it.
embeddedStatusReportEnabled in UL-AM-RLC IE: indicates that embedded STATUS report transmission associated functions are enabled (e.g. determining to insert embedded STATUS report in a AMD PDU; determining value to be comprised in ACK_SN_1/ACK_SN_2 field etc). t-retransmission may implicitly indicate it.
t-retransmission: indicates timer for triggering autonomous retransmission based on embedded STATUS report. RLC transmitting entity starts this timer for a RLC SDU upon submitting the RLC SDU to the lower layer (transmitting the RLC SDU to the peer RLC entity). UE may perform autonomous retransmission of a RLC SDU after this timer expires.

If 12 bit SN is configured and embedded Status Report is enabled (e.g. embeddedStatusReportEnabled and t-embeddedStatusReport are configured):
ACK_SN_1 field is present in all AMD PDUs.
t-StatusProhibit2 is not configured.

If 18 bit SN is configured and embedded Status Report is enabled, ACK_SN_2 and optionally SO_end are present in some AMD PDUs when a specific conditions are met.

If embedded STATUS report is enabled, an AMD PDU header contains a D/C, a P, a SI, a SN and ACK_SN_1. An AMD PDU header contains the SO field only when the Data field consists of an RLC SDU segment which is not the first segment, in which case a 16 bit SO is present.

### UE/GNB Operation

UE receives from a GNB a RRCReconfiguration message.

UE performs with GNB RLC data transfer for a AM DRB.

UE performs following for a AM DRB for which embedded status report is not enabled; <operation for full status reporting> and <operation for retransmission based on full STATUS report>.

UE performs following for a AM DRB for which embedded status report is enabled; <operation for full status reporting>, <operation for retransmission based on full STATUS report>, <operation for embedded status reporting> and <operation for retransmission based on embedded STATUS report>.

### Operation for Full Status Reporting

An AM RLC entity sends STATUS PDUs to its peer AM RLC entity in order to provide positive and/or negative acknowledgements of RLC SDUs (or portions of them).

Triggers to initiate STATUS reporting include:
Polling from its peer AM RLC entity:
   When an AMD PDU with SN=x and the P field set to “1” is received from lower layer:
      if the AMD PDU is to be discarded as specified in clause 5.2.3.2.2; or
      if x<RX_Highest_Status or x>=RX_Next+AM_Window_Size:
         the receiving side of an AM RLC entity shall trigger a STATUS report.
      else:
         the receiving side of an AM RLC entity shall delay triggering the STATUS report until x<RX_Highest_Status or x>=RX_Next+AM_Window_Size.
Detection of reception failure of an AMD PDU
   The receiving side of an AM RLC entity shall trigger a STATUS report when t-Reassembly expires.

The expiry of t-Reassembly triggers both RX_Highest_Status to be updated and a STATUS report to be triggered, but the STATUS report shall be triggered after RX_Highest_Status is updated.

When STATUS reporting has been triggered,:
if t-StatusProhibit is not running:
   at the first transmission opportunity indicated by lower layer, the receiving side of an AM RLC entity shall construct a STATUS PDU and submit it to lower layer.
else:
   at the first transmission opportunity indicated by lower layer after t-StatusProhibit expires, the receiving side of an AM RLC entity shall construct a single STATUS PDU even if status reporting was triggered several times while t-StatusProhibit was running and submit it to lower layer.

When a STATUS PDU has been submitted to lower layer, the receiving side of an AM RLC entity shall start t-StatusProhibit.

When constructing a STATUS PDU,:
for the RLC SDUs with SN such that RX_Next<=SN<RX_Highest_Status that has not been completely received yet, in increasing SN order of RLC SDUs and increasing byte segment order within RLC SDUs, starting with SN=RX_Next up to the point where the resulting STATUS PDU still fits to the total size of RLC PDU(s) indicated by lower layer:
   for an RLC SDU for which no byte segments have been received yet:
      the AM RLC entity shall include in the STATUS PDU a NACK_SN which is set to the SN of the RLC SDU.
   for a continuous sequence of byte segments of a partly received RLC SDU that have not been received yet:
      the AM RLC entity shall include in the STATUS PDU a set of NACK_SN, SOstart and SOend.
   for a continuous sequence of RLC SDUs that have not been received yet:
      the AM RLC entity shall include in the STATUS PDU a set of NACK_SN and NACK range;
the AM RLC entity shall include in the STATUS PDU, if required, a pair of SOstart and SOend.
the AM RLC entity shall set the ACK_SN to the SN of the next not received RLC SDU which is not indicated as missing in the resulting STATUS PDU.

### Operation for Retransmission Based on Full STATUS Report

The transmitting side of an AM RLC entity can receive a negative acknowledgement (notification of reception failure by its peer AM RLC entity) for an RLC SDU or an RLC SDU segment by the following:
STATUS PDU from its peer AM RLC entity.

When receiving a negative acknowledgement for an RLC SDU or an RLC SDU segment by a STATUS PDU from its peer AM RLC entity,:
if the SN of the corresponding RLC SDU falls within the range TX_Next_Ack<=SN<=the highest SN of the AMD PDU among the AMD PDUs submitted to lower layer:
   the transmitting side of the AM RLC entity shall consider the RLC SDU or the RLC SDU segment for which a negative acknowledgement was received for retransmission.

When an RLC SDU or an RLC SDU segment is considered for retransmission,:
if the RLC SDU or RLC SDU segment is considered for retransmission for the first time:
   the transmitting side of the AM RLC entity shall set the RETX_COUNT associated with the RLC SDU to zero.
else, if it (the RLC SDU or the RLC SDU segment that is considered for retransmission) is not pending for retransmission already and the RETX_COUNT associated with the RLC SDU has not been incremented due to another negative acknowledgment in the same STATUS PDU:
   the transmitting side of the AM RLC entity shall increment the RETX_COUNT.
if RETX_COUNT=maxRetxThreshold:
   the transmitting side of the AM RLC entity shall indicate to upper layers that max retransmission has been reached.

### retransmission

When retransmitting an RLC SDU or an RLC SDU segment,:
if needed, segment the RLC SDU or the RLC SDU segment;
the transmitting side of an AM RLC entity shall form a new AMD PDU which will fit within the total size of AMD PDU(s) indicated by lower layer at the particular transmission opportunity;
the transmitting side of an AM RLC entity shall submit the new AMD PDU to lower layer.

When forming a new AMD PDU,:
the transmitting side of an AM RLC entity shall only map the original RLC SDU or RLC SDU segment to the Data field of the new AMD PDU;
the transmitting side of an AM RLC entity shall modify the header of the new AMD PDU as required;
the transmitting side of an AM RLC entity shall set the P field if required.

For the RLC entity associated with a radio bearer that is not configured for delay-sensitive operation, UE performs followings (second retransmission mechanism).

When an RLC SDU or an RLC SDU segment is considered for retransmission:
if the RLC SDU or RLC SDU segment is considered for retransmission for the first time:
   the transmitting side of the AM RLC entity shall set the RETX_COUNT associated with the RLC SDU to zero.
else, if the RLC SDU or the RLC SDU segment, that is considered for retransmission, is not pending for retransmission already and the RETX_COUNT associated with the RLC SDU has not been incremented due to another negative acknowledgment in the same STATUS PDU:
the transmitting side of the AM RLC entity shall increment the RETX_COUNT.
if RETX_COUNT=maxRetxThreshold:
   UE performs cell selection and RRC connection re-establishment procedure.

For the RLC entity associated with a radio bearer that is configured for delay-sensitive operation, UE performs followings (first retransmission mechanism).

When an RLC SDU or an RLC SDU segment is considered for retransmission:
if the RLC SDU or RLC SDU segment is considered for retransmission for the first time:
   the transmitting side of the AM RLC entity shall set the RETX_COUNT associated with the RLC SDU to zero.
else:
   if the RLC SDU or the RLC SDU segment, that is considered for retransmission, is not pending for retransmission already and the RETX_COUNT associated with the RLC SDU has not been incremented due to another negative acknowledgment in the same STATUS PDU; and
   if the RLC SDU or the RLC SDU segment is considered for retransmission due to reception of negative acknowledgement for an RLC SDU or an RLC SDU segment by a STATUS PDU:
      the transmitting side of the AM RLC entity shall increment the RETX COUNT.
   else if the RLC SDU is considered for retransmission due to that remaining time associated with the RLC SDU is less than remainingTimeThreshold:
      the transmitting side of the AM RLC entity shall not increment the REXT_COUNT;
if RETX_COUNT=maxRetxThreshold:
   UE performs cell selection and RRC connection re-establishment procedure.

### Operation for Embedded Status Reporting

An AM RLC entity sends embedded STATUS report to its peer AM RLC entity in order to provide positive acknowledgements of one or more RLC SDUs (and negative acknowledgement of a RLC SDU).

An AM RLC entity inserts embedded STATUS report (ACK_SN_1 field) in all AMD PDUs once the AM RLC entity is configured with embedded STATUS report by RRC.

The embedded STATUS report is inserted between AMD PDU header portion and AMD PDU Data field.

When constructing a AMD PDU, the AM RLC entity shall include in the AMD PDU an ACK_SN_1 which is set to specific portion (e.g. 8 LSBs) of RX_NEXT (or other values/variables).

### Operation for Retransmission Based on Embedded STATUS Report

The transmitting side of an AM RLC entity can receive a positive acknowledgement (notification of successful reception by its peer AM RLC entity) for an RLC SDU or an RLC SDU segment that may cause retransmission by the following:
Embedded STATUS report from its peer AM RLC entity.

When receiving a negative acknowledgement for an RLC SDU by an embedded STATUS report from its peer AM RLC entity (e.g. ACK_SN_1 field indicate RX_NEXT),:
if t-retransmission of the RLC SDU is running,
   the transmitting side of the AM RLC entity shall wait until t-retransmission of the RLC SDU expires;
if t-retransmission of the RLC SDU is not running or has expired,
   if the SN of the corresponding RLC SDU falls within the range TX_Next_Ack<=SN<=the highest SN of the AMD PDU among the AMD PDUs submitted to lower layer;
      the transmitting side of the AM RLC entity shall consider the RLC SDU for which a negative acknowledgement was received for retransmission.

The transmitting side of the AM RLC entity does not initialize or update RETX_COUNT when retransmitting RLC SDU based on embedded STATUS report.

Retransmission of a single RLC SDU is performed when the retransmission is determined based on embedded STATUS report.

Retransmission of a one or more RLC SDUs and one or more RLC SDU segments are performed when the retransmission is determined based on full STATUS report.

When retransmitting an RLC SDU,:
if needed, the transmitting side of an AM RLC entity shall segment the RLC SDU;
the transmitting side of an AM RLC entity shall form a new AMD PDU which will fit within the total size of AMD PDU(s) indicated by lower layer at the particular transmission opportunity;
the transmitting side of an AM RLC entity shall submit the new AMD PDU to lower layer.

When forming a new AMD PDU,:
the transmitting side of an AM RLC entity shall only map the original RLC SDU to the Data field of the new AMD PDU;
the transmitting side of an AM RLC entity shall modify the header of the new AMD PDU as required;
set the P field if required.

The transmitting side of an AM RLC entity can receive a positive acknowledgement (confirmation of successful reception by its peer AM RLC entity) for an RLC SDU by the following:
STATUS PDU from its peer AM RLC entity.

When receiving a positive acknowledgement for an RLC SDU with SN=x,:
the transmitting side of an AM RLC entity shall send an indication to the upper layers of successful delivery of the RLC SDU;
the transmitting side of an AM RLC entity shall set TX_Next_Ack equal to the SN of the RLC SDU with the smallest SN, whose SN falls within the range TX_Next_Ack<=SN<=TX_Next and for which a positive acknowledgment has not been received yet.

### Alternative Operation for Embedded Status Reporting

An AM RLC entity sends embedded STATUS report to its peer AM RLC entity in order to provide positive acknowledgements of one or more RLC SDUs (and negative acknowledgement of a RLC SDU).

An AM RLC entity inserts embedded STATUS report (ACK_SN_2 field and optionally SO_END_1 field) in specific AMD PDUs upon specific events.

The specific events are:
Rx_Next is updated;
Rx_Last_Insequence is updated (e.g. due to new RLC SDU delivered to the upper layer);
Rx_Highest_Rcvd is updated;
Rx_Latest_Rcvd is updated (e.g. due to successful reception of new RLC SDU); or
RLC SN to be indicated in ACK_SN_2 field of the new embedded STATUS report is different from what is reported in ACK_SN_2 field of the latest embedded STATUS report.

The specific AMD PDUs are n consecutive AMD PDUs to be transmitted after the specific event occurs. n is indicated in RRCReconfiguration message or is predefined to a fixed value.

The embedded STATUS report is inserted between AMD PDU header portion and AMD PDU Data field.

When constructing a AMD PDU,
the AM RLC entity shall set ACK_SN_2 field with the Rx_Next/Rx_Last_Insequence/Rx_Highest_Rcvd/Rx_Latest_Rcvd;
the AM RLC entity shall set SO_END_1 field with a value corresponding to the first byte of the portion of the RLC SDU that is negatively acknowledge (or the last byte of the portion of the RLC SDU that is successfully received).

### Alternative Operation for Retransmission Based on Embedded STATUS Report

The transmitting side of an AM RLC entity can receive a positive acknowledgement (notification of successful reception by its peer AM RLC entity) for an RLC SDU or an RLC SDU segment that may cause retransmission by the following embedded STATUS report from its peer AM RLC entity.

When receiving an embedded STATUS report that contains ACK_SN_2 field without SO_END_1 field, UE performs retransmission of the RLC SDU according to table 3 and table 4.

TABLE 3

| CASE | Negative Acknowledgement | Positive Acknowledgement |
|---|---|---|
| ACK_SN_2 field | RLC SDU of RLC SN | RLC SDUs within the range |
| contains Rx_Next | corresponding to ACK_SN_2 | Tx_Next_Ack < SN < |
| | | ACK_SN_2 |
| ACK_SN_2 field | RLC SDU of RLC SN | RLC SDUs within the range |
| contains Rx_Last_ | corresponding to | Tx_Next_Ack < SN <= |
| Insequence | ACK_SN_2 + 1 | ACK_SN_2 |
| ACK_SN_2 field | RLC SDU of RLC SN | RLC SDU of ACK_SN_2 |
| contains | corresponding to | |
| Rx_Highest_Rcvd | ACK_SN_2 + 1 | |
| ACK_SN_2 field | None | RLC SDU of ACK_SN_2 |
| contains | | |
| Rx_Latest_Rcvd | | |

TABLE 4

| | Retransmission | |
|---|---|---|
| | (the RLC SDU | |
| | in this column = | |
| | RLC SDU that | Indication of |
| | is negatively | successful delivery |
| | acknowledged by | to the upper layer & |
| | the embedded | Tx_Next_Ack |
| CASE | STATUS report) | update |
| ACK_SN_2 field | When t-retransmission of the | Successful delivery |
| contains Rx_Next | RLC SDU expires, if the RLC | of RLC SDUs within |
| | SDU is acknowledged neither | the following range are |
| | by full STATUS report nor | indicated to the upper layer: |
| | by another embedded STATUS | Tx_Next_Ack < SN < ACK_SN_2 |
| | report, the RLC SDU is | Tx_Next_ACK is update to |
| | retransmitted. | ACK_SN_2 |
| ACK_SN_2 field | When t-retransmission of the | Successful delivery of RLC |
| contains | RLC SDU expires, if the RLC | SDUs within the following range |
| Rx_Last_Insequence | SDU is acknowledged neither | are indicated to the upper layer: |
| | by full STATUS report nor by | Tx_Next_Ack < SN < ACK_SN_2 |
| | another embedded STATUS | Tx_Next_ACK is update to |
| | report, the RLC SDU is | ACK_SN_2 + 1 |
| | retransmitted. | |
| ACK_SN_2 field | When r-transmission of the | Successful delivery of RLC SDUs |
| contains | RLC SDU expires, if the RLC | within the following range are |
| Rx_Highest_Rcvd | SDU is acknowledged neither | indicated to the upper layer: |
| | by full STATUS report nor by | SN = ACK_SN_2 |
| | another embedded STATUS | Tx_Next_ACK is update to |
| | report, the RLC SDU is | ACK_SN_2 + 1 |
| | retransmitted. | |
| ACK_SN_2 field | If a RLC SDU have been | Successful delivery of RLC SDUs |
| contains | transmitted before RLC SDU | within the following range are |
| Rx_Latest_Rcvd | of ACK_SN_2 (RLC SDU | indicated to the upper layer: |
| | with SN lower than | SN = ACK_SN_2 |
| | ACK_SN_2) and has not bee | Tx_Next_ACK is update to |
| | positively acknowledged, the | ACK_SN_2 + 1 |
| | RLC SDU is retransmitted. | |

When receiving an embedded STATUS report that contains ACK_SN_2 field and SO_END_1 field, UE performs retransmission of the portion of RLC SDU according to table 5 and table 6.

TABLE 5

| | Negative Acknowledgement | Positive Acknowledgement |
|---|---|---|
| ACK_SN_2 field | Portion of RLC SDU with | RLC SDUs within the range |
| contains Rx_Next | RLC SN corresponding to | Tx_Next_Ack < SN < |
| | ACK_SN_2 | ACK_SN_2 |
| | Portion of RLC SDU: from | |
| | the next byte indicated by | |
| | SO_END_1 to the last byte | |
| | of the RLC SDU | |
| ACK_SN_2 field | Portion of RLC SDU of | RLC SDUs within the range |
| contains | RLC SN corresponding to | Tx_Next_Ack < SN <= |
| Rx_last_Insequence | ACK_SN_2 + 1 | ACK_SN_2 |
| | Portion of RLC SDU: from | |
| | the next byte indicated by | |
| | SO_END_1 to the last byte | |
| | of the RLC SDU | |
| ACK_SN_2 field | Portion of RLC SDU of | RLC SDU of SCK_SN_2 |
| contains | RLC SN corresponding to | |
| Rx_Highest_Rcvd | ACK_SN_2 + 1 | |
| | Portion of RLC SDU: from | |
| | the next byte indicated by | |
| | SO_END_1 to the last byte | |
| | of the RLC SDU | |
| ACK_SN_2 field | None | RLC SDU of ACK_SN_2 |
| contains | | |
| Rx_Latest_Rcvd | | |

TABLE 6

| | Retransmission | |
|---|---|---|
| | (the portion of the RLC | |
| | SDU in this column = | |
| | portion of RLC SDU | |
| | that is negatively | Indication of successful |
| | acknowledged by the | delivery to the upper |
| | embedded STATUS | layer & Tx_Next_Ack |
| | report) | update |
| ACK_SN_2 field | When t-retransmission | Successful delivery of |
| contains Rx_Next | of the RLC SDU expires, | RLC SDUs within the |
| | if the portion of RLC SDU | following range are |
| | is acknowledged neither | indicated to the upper |
| | by full STATUS report | layer: |
| | nor by another embedded | Tx_Next_Ack < SN < ACK_SN_2 |
| | STATUS report, the portion | Tx_Next_ACK is update to |
| | of RLC SDU is retransmitted | ACK_SN_2 |
| ACK_SN_2 field | When t-retransmission of the | Successful delivery of RLC SDUs |
| contains | RLC SDU expires, if the | within the following range are |
| Rx_Last_Insequence | portion of RLC SDU is | indicated to the upper layer: |
| | acknowledged neither by | Tx_Next_Ack < SN <= ACK_SN_2 |
| | full STATUS report, the | Tx_Next_ACK is update to |
| | portion of RLC SDU is | ACK_SN_2 + 1 |
| | retransmitted. | |
| ACK_SN_2 field | When t-retransmission of | Successful delivery of RLC SDUs |
| contains | the RLC SDU expires, if the | within the following range are |
| Rx_Highest_Rcvd | portion of RLC SDU is | indicated to the upper layer: |
| | acknowledged neither by | SN = ACK_SN_2 |
| | full STATUS report nor by | Tx_Next_ACK is update to |
| | another embedded STATUS | ACK_SN_2 + 1 |
| | report, the portion of RLC | |
| | SDU is retransmitted. | |
| ACK_SN_2 field | If a RLC SDU have been | Successful delivery of RLC SDUs |
| contains | transmitted before RLC | within the following range are |
| Rx_Highest_Rcvd | SDU of ACK_SN_2 (with | indicated to the upper layer: |
| | SN lower than ACK_SN_2) | SN = ACK_SN_2 |
| | and has not bee positively | Tx_Next_ACK is update to |
| | acknowledged, the RLC | ACK_SN_2 + 1 |
| | SDU is retransmitted. | |

The transmitting side of the AM RLC entity does not initialize or update RETX_COUNT when retransmitting RLC SDU based on embedded STATUS report.

Retransmission of a single RLC SDU (or a portion of a RLC SDU) is performed when the retransmission is determined based on embedded STATUS report.

Retransmission of a one or more RLC SDUs and one or more RLC SDU segments are performed when the retransmission is determined based on full STATUS report.

When retransmitting an RLC SDU,:
if needed, the transmitting side of an AM RLC entity shall segment the RLC SDU;
the transmitting side of an AM RLC entity shall form a new AMD PDU which will fit within the total size of AMD PDU(s) indicated by lower layer at the particular transmission opportunity;
the transmitting side of an AM RLC entity shall submit the new AMD PDU to lower layer.

When forming a new AMD PDU,:
the transmitting side of an AM RLC entity shall only map the original RLC SDU to the Data field of the new AMD PDU;
the transmitting side of an AM RLC entity shall modify the header of the new AMD PDU if required;
the transmitting side of an AM RLC entity shall set the P field if required.

The transmitting side of an AM RLC entity can receive a positive acknowledgement (confirmation of successful reception by its peer AM RLC entity) for an RLC SDU by the following:
full STATUS PDU from its peer AM RLC entity;
embedded STATUS report from its peer AM RLC entity.

When receiving a positive acknowledgement for an RLC SDU with SN=x,:
the transmitting side of an AM RLC entity shall send an indication to the upper layers of successful delivery of the RLC SDU;
the transmitting side of an AM RLC entity shall set TX_Next_Ack equal to the SN of the RLC SDU with the smallest SN, whose SN falls within the range TX_Next_Ack<=SN<=TX_Next and for which a positive acknowledgment has not been received yet.
   An AMD PDU contains either one complete RLC SDU or one RLC SDU segment. AMD PDU consists of a Data field and an AMD PDU header. The Data field comprises one complete RLC SDU or one RLC SDU segment.

### Polling

Upon notification of a transmission opportunity by lower layer, for each AMD PDU submitted for transmission such that the AMD PDU contains either a not previously transmitted RLC SDU or an RLC SDU segment containing not previously transmitted byte segment:
the transmitting side of an AM RLC entity shall increment PDU_WITHOUT_POLL by one;
the transmitting side of an AM RLC entity shall increment BYTE_WITHOUT_POLL by every new byte of Data field element that it maps to the Data field of the AMD PDU;
if PDU_WITHOUT_POLL>=pollPDU; or
if BYTE_WITHOUT_POLL>=pollByte:
the transmitting side of an AM RLC entity shall include a poll in the AMD PDU as described below.

Upon notification of a transmission opportunity by lower layer, for each AMD PDU submitted for transmission:
if both the transmission buffer and the retransmission buffer become empty (excluding transmitted RLC SDUs or RLC SDU segments awaiting acknowledgements) after the transmission of the AMD PDU; or
if no new RLC SDU can be transmitted after the transmission of the AMD PDU (e.g. due to window stalling); or
if upper layer has indicated that polling is required (or if upper layer has requested RLC entity to inform PDCP entity whether a RLC SDU has been successfully transmitted) and AMD PDU including a poll has not been transmitted since then (and successful delivery of at least part of the RLC SDU has not been confirmed):
the transmitting side of an AM RLC entity shall include a poll in the AMD PDU as described below.

When upper layer requests status of a RLC SDU, and at the time when notification of a transmission opportunity by lower layer occurs first time since then:
UE includes a Poll in the AMD PDU:
   If all byte of the RLC SDU has been transmitted; and
   If all bytes of the RLC SDU has not been positively acknowledged;
UE performs transmission of bytes of the RLC SDU that has not been transmitted:
   If some byte of the RLS SDU has not been transmitted.
UE performs retransmission of bytes of RLC SDU that has been transmitted and not has been positively acknowledged.

To include a poll in an AMD PDU:
the transmitting side of an AM RLC entity shall set the P field of the AMD PDU to “1”;
the transmitting side of an AM RLC entity shall set PDU_WITHOUT_POLL to 0;
the transmitting side of an AM RLC entity shall set BYTE_WITHOUT_POLL to 0.

Upon submission of an AMD PDU including a poll to lower layer, if the poll is included in the AMD PDU not due to request from upper layer:
the transmitting side of an AM RLC entity shall set POLL_SN to the highest SN of the AMD PDU among the AMD PDUs submitted to lower layer;
if t-PollRetransmit is not running:
   the transmitting side of an AM RLC entity shall start t-PollRetransmit.
else:
   the transmitting side of an AM RLC entity shall restart t-PollRetransmit.

Upon submission of an AMD PDU including a poll to lower layer, if the poll is included in the AMD PDU due to request from upper layer:
the transmitting side of an AM RLC entity shall set POLL_SN_1 to the SN of the AMD PDU that contains the RLC SDU of which status was requested by upper layer;
if t-PollRetransmit_1 is not running:
   the transmitting side of an AM RLC entity shall start t-PollRetransmit_1.
else:
   the transmitting side of an AM RLC entity shall restart t-PollRetransmit_1.

Upon reception of a STATUS report from the receiving RLC AM entity:
if the STATUS report comprises a positive or negative acknowledgement for the RLC SDU with sequence number equal to POLL_SN:
   if t-PollRetransmit is running:
   the transmitting side of an AM RLC entity shall stop and reset t-PollRetransmit.
if the STATUS report comprises a positive or negative acknowledgement for the RLC SDU with sequence number equal to POLL_SN_1:
   if t-PollRetransmit_1 is running:
   the transmitting side of an AM RLC entity shall stop and reset t-PollRetransmit_1.

Upon expiry of t-PollRetransmit:
if both the transmission buffer and the retransmission buffer are empty (excluding transmitted RLC SDU or RLC SDU segment awaiting acknowledgements); or
if no new RLC SDU or RLC SDU segment can be transmitted (e.g. due to window stalling):
   the transmitting side of an AM RLC entity shall consider the RLC SDU with the highest SN among the RLC SDUs submitted to lower layer for retransmission; or
   the transmitting side of an AM RLC entity shall consider any RLC SDU which has not been positively acknowledged for retransmission.
the transmitting side of an AM RLC entity shall include a poll in an AMD PDU.

Upon expiry of t-PollRetransmit_1:
the transmitting side of an AM RLC entity shall consider the RLC SDU of which status was requested by upper layer (e.g. RLC SDU associated with POLL_SN_1) for retransmission.
the transmitting side of an AM RLC entity shall include a poll in an AMD PDU that contains the RLC SDU of which status was requested by upper layer.

### DSR

The Delay Status Reporting (DSR) procedure is used to provide the serving gNB with delay status of LCGs. This delay status for an LCG includes remaining time, which is the smallest remaining value of the running PDCP discardTimers among PDCP SDUs that are buffered for the LCG but have not been transmitted in any MAC, and the total amount of delay-critical UL data for the LCG according to the data volume calculation procedure for the associated RLC and PDCP entities, respectively.

RRC controls the DSR procedure by configuring the following parameter:
remainingTimeThreshold (per LCG): the threshold on remaining time for triggering a DSR for a logical channel within an LCG.

If an LCG is configured for delay status reporting, the MAC entity shall for each logical channel within the LCG:
if the smallest remaining value of the running PDCP discardTimers among all the PDCP SDUs buffered for the logical channel that have not been transmitted in any MAC PDU and have not been reported as data volume in a DSR MAC CE becomes below remainingTimeThreshold of the LCG; and
if there is no DSR pending for the logical channel:
   trigger a DSR for the logical channel.

If there is at least one DSR pending, the MAC entity shall:
if UL-SCH resources are available for a new transmission and the UL-SCH resources can accommodate the DSR MAC CE plus its subheader as a result of logical channel prioritization:
   instruct the Multiplexing and Assembly procedure to generate the DSR MAC CE.
else if there is no pending SR already triggered by the DSR procedure for the same logical channel as of this DSR:
   trigger a Scheduling Request.

A PDCP SDU is considered to be associated with a DSR if it has not been transmitted in any MAC PDU and is a delay-critical PDCP SDU associated with the logical channel which triggered the DSR.

A MAC PDU shall contain at most one DSR MAC CE. A MAC PDU shall not contain a DSR MAC CE if it includes all PDCP SDUs associated with all the pending DSRs.

After a DSR is triggered, it is considered as pending until it is cancelled. The MAC entity shall cancel a pending DSR, when all the PDCP SDUs associated with the DSR have been discarded, or when a MAC PDU is transmitted and this MAC PDU includes a DSR MAC CE that contains the delay information of all the PDCP SDUs associated with the DSR, or when a MAC PDU is transmitted and this MAC PDU includes all the PDCP SDUs associated with the DSR.

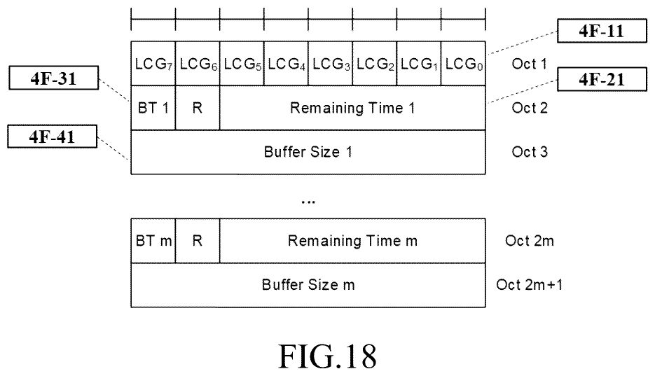

FIG. 18 illustrates Delay Status Report format.

The Delay Status Report (DSR) MAC CE is identified by MAC subheader with an eLCID.

The fields in the DSR MAC CE are defined as follows:
LCGi 4F-11: This field indicates the presence of delay information (i.e. the Remaining Time and Buffer Size fields) for the LCG i. The LCGi field set to 1 indicates that the delay information for the LCG i is reported. The LCGi field set to 0 indicates that the delay information for the LCG i is not reported;
Remaining Time 4F-21: This field indicates the shortest remaining value of running PDCP discardTimer among all PDCP SDUs that are buffered for an LCG but have not been transmitted in any MAC PDU, at the time of the first symbol of the first PUSCH transmission that includes this DSR MAC CE. The length of this field is 6 bits. This field is present only if the buffer size indicated by the corresponding Buffer Size field is not zero; otherwise, this field is reserved and set to 0. If present, the value r in this field indicates a remaining time within the range of [r, r+1] msec;
BT 4F-31: This field is present only if the corresponding LCG is configured with additionalBS-TableAllowed and the buffer size indicated by the corresponding Buffer Size field is not zero; otherwise, this field is reserved and set to 0. If present, the BT field set to 1 indicates that the buffer sizes specified in the additional bufer size table are used to set the value of the Buffer Size field, while the BT field set to 0 indicates that the buffer sizes specified in the baseline buffer size table are used instead;
Buffer Size 4F-41: The Buffer Size field indicates the total amount of delay-critical UL data for an LCG according to the data volume calculation procedure for the associated RLC and PDCP entities, respectively, after the MAC PDU has been built. If the corresponding LCG is configured with additionalBS-TableAllowed and the amount of delay-critical UL data for an LCG is within the buffer sizes specified in additinoal buffer size table, the MAC entity shall use the buffer sizes specified in the additinoal buffer size table to set the value of this field; otherwise, the MAC entity shall use baseline buffer size table instead. This field is indicated in number of bytes. The length of this field is 8 bits;
R: Reserved bit, set to 0.

The DSR MAC CE shall include delay information of all LCGs which have pending DSRs when the MAC PDU containing this DSR MAC CE is to be built. The Remaining Time, the BT, and the Buffer Size fields for an LCG shall be reported in two consecutive octets. These three fields for different LCGs shall be included in a DSR MAC CE in ascending order based on the LCGi.

The IE MAC-CellGroupConfig is used to configure MAC parameters for a cell group, including DRX.

```
  -- ASN1START
  -- TAG-MAC-CELLGROUPCONFIG-START
```

| | |
|---|---|
| MAC-CellGroupConfig ::= | SEQUENCE { |
| drx-Config | SetupRelease { DRX-Config } |
| schedulingRequestConfig | SchedulingRequestConfig |
| bsr-Config | BSR-Config |
| tag-Config | TAG-Config |
| ..., | |
| additionalBS-TableAllowed-r18 | BIT STRING (SIZE (maxNrofLCGs-r18)) |
| dsr-ConfigToAddModList-r18 | SEQUENCE (SIZE (1..maxNrofLCGs- |
| r18)) OF LCG-DSR-Config-r18 | OPTIONAL, -- Need N |
| dsr-ConfigToReleaseList-r18 | SEQUENCE (SIZE (1..maxNrofLCGs-r18)) |
| OF LCG-Id-r18 | OPTIONAL, -- Need N |
| tar-Config-r18 | SetupRelease { TAR-Config-r18 } |
| OPTIONAL -- Need M | |
| ]] | |
| } | |

LCG-DSR-Config-r18 ::= SEQUENCE {

| | |
|---|---|
| lcg-Id-r18 | LCG-Id-r18, |
| remainingTimeThreshold-r18 | INTEGER (1..64), |
| ... | |

```
  }
  LCG-ID-r18 ::= INTEGER (0..maxLCG-ID)
  -- TAG-MAC-CELLGROUPCONFIG-STOP
  -- ASN1STOP
```

additionalBS-TableAllowed field indicates whether a UE is allowed to utilize the refined buffer size levels for a certain Logical Channel Group. The leftmost bit corresponds to LCG ID=0, second leftmost bit to LCG ID=1 and so on. The UE is allowed to utilize the refined buffer size levels for a Logical Channel Group only when the corresponding bit is set to 1.
dsr-ConfigToAddModList field contains list of LCG-specific DSR configurations to add or modify.
remainingTimeThreshold field indicates remaining time threshold used for triggering DSR for the logical channels belonging to this Logical Channel Group. Value in number of milliseconds.

### PDCP PDU; Security

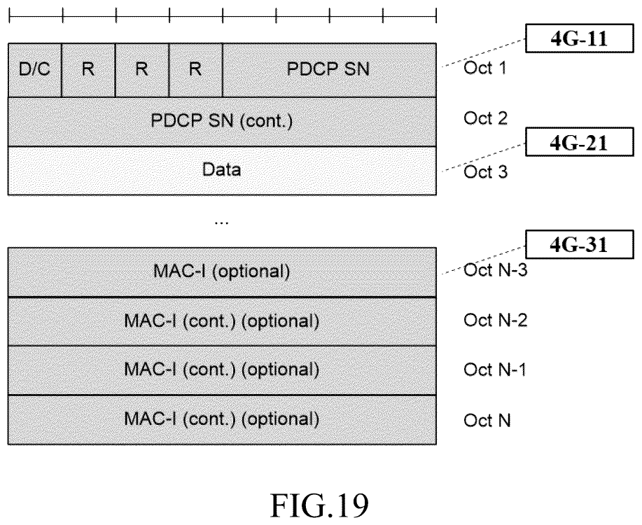

FIG. 19 illustrates PDCP data PDU formats.

PDCP Data PDU consists of PDCP header 4G-11, Data 4G-21 and MAC-I 4G-31. PDCP header includes D/C field and PDCP SN field.

Data includes one of the followings:
Uncompressed PDCP SDU (user plane data, or control plane data);
Compressed PDCP SDU (user plane data only).

Length of MAC-I field is 32 bit. This field carries a message authentication code calculated.

The ciphering function includes both ciphering and deciphering and is performed in PDCP, if configured. The data unit that is ciphered is the MAC-I and the data part of the PDCP Data PDU except the SDAP header and the SDAP Control PDU if included in the PDCP SDU.

For downlink and uplink, the ciphering algorithm and key to be used by the PDCP entity are configured by RRC (determined based on information indicated by RRCReconfiguration message).

The ciphering function is activated/suspended/resumed by RRC. When security is activated and not suspended, the ciphering function shall be applied to all PDCP Data PDUs.

The required inputs to the ciphering function include the COUNT value, and DIRECTION (direction of the transmission). The parameters required by PDCP are listed below:
BEARER (defined as the radio bearer identifier. It will use the value RB identity −1);
KEY (the ciphering keys for the control plane and for the user plane are KRRCenc and K_{UPenc}, respectively).

The integrity protection function includes both integrity protection and integrity verification and is performed in PDCP, if configured. The data unit that is integrity protected is the PDU header and the data part of the PDU before ciphering. The integrity protection is always applied to PDCP Data PDUs of SRBs. The integrity protection is applied to PDCP Data PDUs of DRBs for which integrity protection is configured.

For downlink and uplink, the integrity protection algorithm and key to be used by the PDCP entity are configured by RRC (determined based on information indicated by RRCReconfiguration message).

The integrity protection function is activated/suspended/resumed by RRC. When security is activated and not suspended, the integrity protection function shall be applied to all PDUs including and subsequent to the PDU indicated by RRC for the downlink and the uplink, respectively.

As the RRC message which activates the integrity protection function is itself integrity protected with the configuration included in this RRC message, this message needs first be decoded by RRC before the integrity protection verification could be performed for the PDU in which the message was received.

The required inputs to the integrity protection function include the COUNT value, and DIRECTION (direction of the transmission). The parameters required by PDCP which are listed below:
BEARER (RB identity −1);
KEY (the integrity protection keys for the control plane and for the user plane are K_{RRCint} and K_{UPint}, respectively).

At transmission, the UE computes the value of the MAC-I field and at reception it verifies the integrity of the PDCP Data PDU by calculating the X-MAC based on the input parameters as specified above. If the calculated X-MAC corresponds to the received MAC-I, integrity protection is verified successfully.

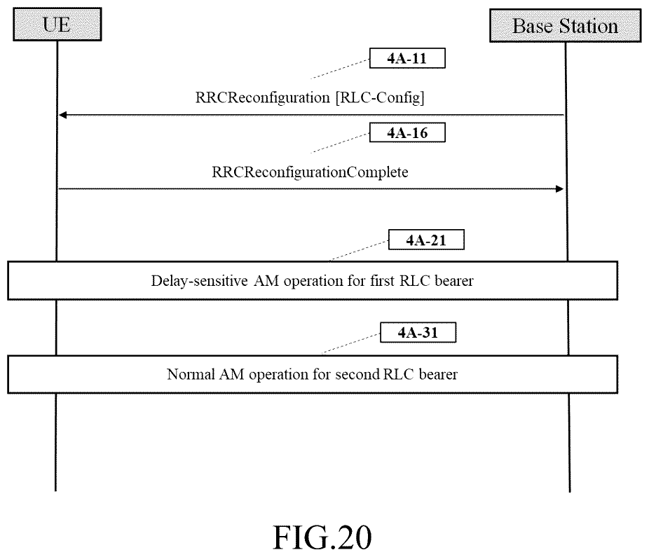

FIG. 20 illustrates signaling sequence to configure enhance ARQ operation.

Base station transmits UE RRCReconfiguration to configure UE with a delay-sensitive AM operation for a first RLC bearer and does not configure delay-sensitive AM operation for a second RLC bearer 4A-11.

To configure delay-sensitive AM operation for the first RLC bearer, a one bit indication can be included in the RLC configuration information for the first RLC bearer.

Base station and UE perform delay-sensitive AM operation and normal AM operation for the first RLC bearer 4A-21.

Base station and UE perform normal AM operation for the second RLC bearer 4A-31.

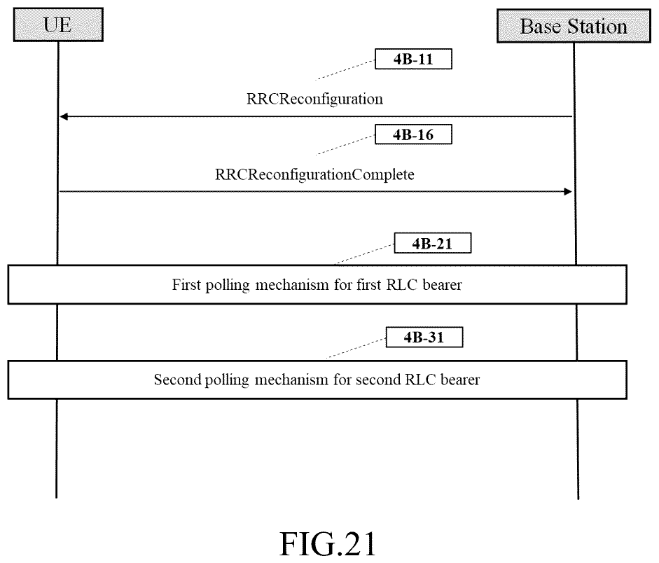

FIG. 21 illustrates normal AM operation of AM RLC entity.

Base station transmits UE RRCReconfiguration to configure UE with first polling mechanism for the first RLC bearer and configures second polling mechanism for the second RLC bearer 4B-11.

To configure first polling mechanism for the first RLC bearer, a one bit indication can be included in the RLC configuration information for the first RLC bearer. To configure second polling mechanism for the first RLC bearer, the one bit indication is not included in the RLC configuration information for the second RLC bearer.

Base station and UE perform first polling mechansim for the first RLC bearer 4B-21.

Base station and UE perform second polling mechanism for the second RLC bearer 4B-31.

In the first polling mechanism, UE includes a poll in an AMD PDU:
if PDU_WITHOUT_POLL>=pollPDU;
if BYTE_WITHOUT_POLL>=pollByte:
if both the transmission buffer and the retransmission buffer become empty (excluding transmitted RLC SDUs or RLC SDU segments awaiting acknowledgements) after the transmission of the AMD PDU;
if no new RLC SDU can be transmitted after the transmission of the AMD PDU (e.g. due to window stalling);
upon expiry of t-PollRetransmit; or
if remaining time of discardTimer of a specific PDCP PDU (RLC SDU) becomes less than remainingTimeForRlcNotification, wherein the specific PDCP PDU (RLC SDU) is the RLC SDU of which at least one byte has been transmitted at least once, for which successful delivery of whole RLC SDU has not been confirmed yet.

In the second polling mechanism, UE includes a poll in an AMD PDU:
if PDU_WITHOUT_POLL>=pollPDU;
if BYTE_WITHOUT_POLL>=pollByte:
if both the transmission buffer and the retransmission buffer become empty (excluding transmitted RLC SDUs or RLC SDU segments awaiting acknowledgements) after the transmission of the AMD PDU;
if no new RLC SDU can be transmitted after the transmission of the AMD PDU (e.g. due to window stalling); or
upon expiry of t-PollRetransmit.

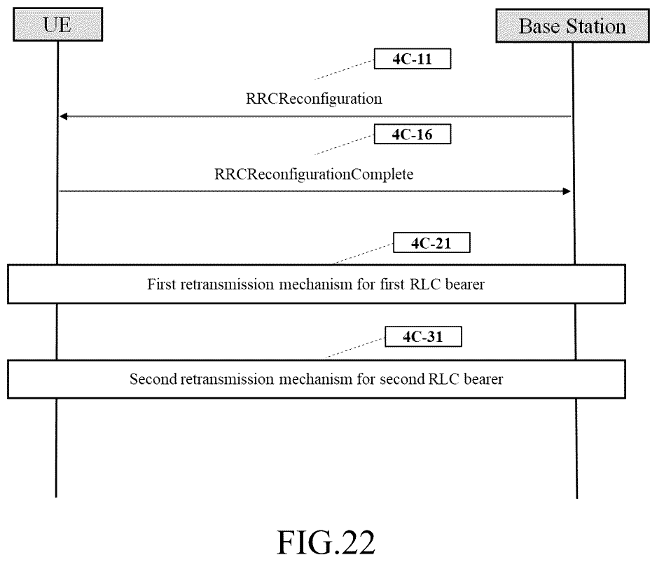

FIG. 22 illustrates retransmission operation.

Base station transmits UE RRCReconfiguration to configure UE with first retransmission mechanism for the first RLC bearer and configures second retransmission mechanism for the second RLC bearer 4C-11.

To configure first retransmission mechanism for the first RLC bearer, a one bit indication can be included in the RLC configuration information for the first RLC bearer. To configure second retransmission mechanism for the first RLC bearer, the one bit indication is not included in the RLC configuration information for the second RLC bearer.

Base station and UE perform first retransmission mechanism for the first RLC bearer 4C-21.

Base station and UE perform second retransmission mechanism for the second RLC bearer 4C-31.

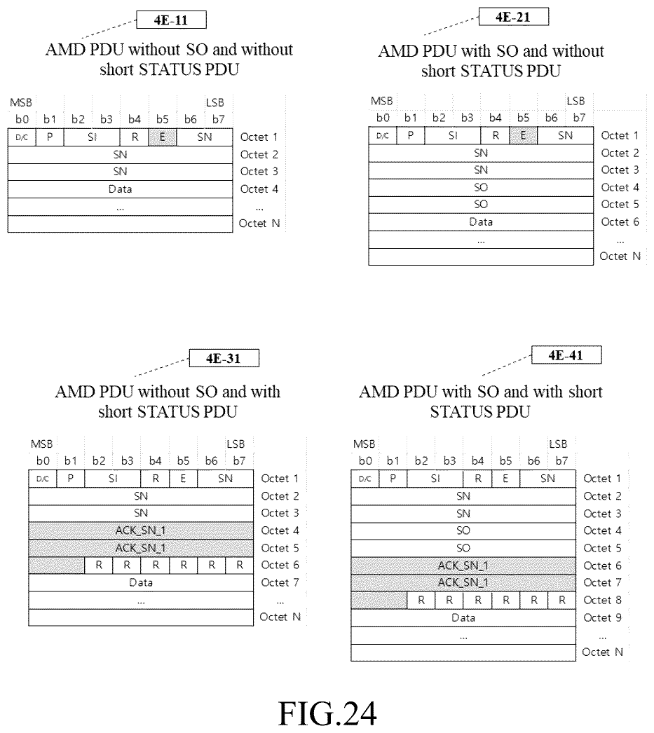

FIG. 24 illustrates AMD PDU formats.

For AM RLC entity that are not configured with delay-sensitive AM operation, AMD PDUs without STATUS PDU 4E-11 and 4E-21 are used except that b5 of Octet 1 is R.

For AM RLC entity that are configured with delay-sensitive AM operation, AMD PDUs without STATUS PDU 4E-11 and 4E-21 and AMD PDUs with STATUS PDU 4E-31 and 4E-41 are used.

E bit indicates whether or not ACK_SN_1 field follows.

If AMD PDU contains a RLC SDU, 4E-11 or 4E-31 are used. If AMD PDU contains a RLC SDU segment, 4E-21 or 4E-41 are used.

The SN field indicates the sequence number of the corresponding RLC SDU. The SI field indicates whether an RLC PDU contains a complete RLC SDU or the first, middle, last segment of an RLC SDU. 00 means that Data field contains all bytes of an RLC SDU. 01 means that Data field contains the first segment of an RLC SDU. 10 means that Data field contains the last segment of an RLC SDU. 11 means that Data field contains neither the first nor last segment of an RLC SDU. The SO field indicates the position of the RLC SDU segment in bytes within the original RLC SDU. The D/C field indicates whether the RLC PDU is an RLC data PDU or RLC control PDU. The P field indicates whether or not the transmitting side of an AM RLC entity requests a STATUS report from its peer AM RLC entity.

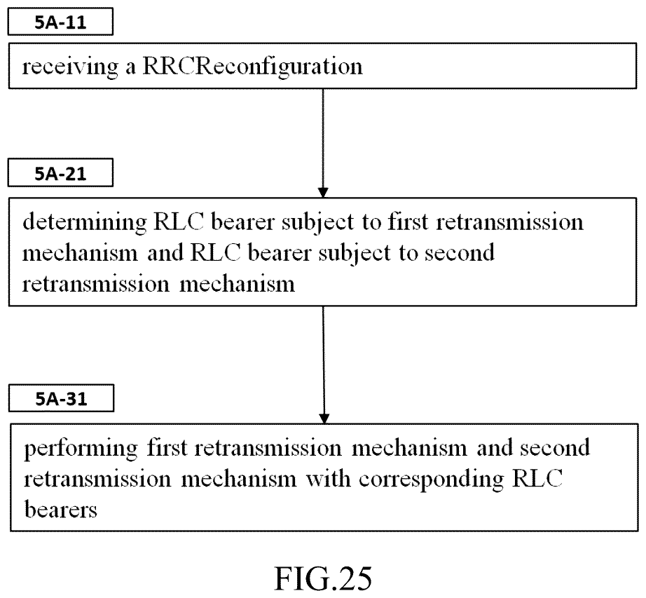

FIG. 25 is a diagram illustrating UE operation.

UE receives from a base station RRCReconfiguration 5A-11.

UE determines the RLC bearer to operate based on first retransmission mechanism and the RLC bearer to operate based on second retransmission mechanism 5A-21.

UE performs the first retransmission mechanism for a specific RLC bearer and the second retransmission mechanism for another specific RLC bearer 5A-31.

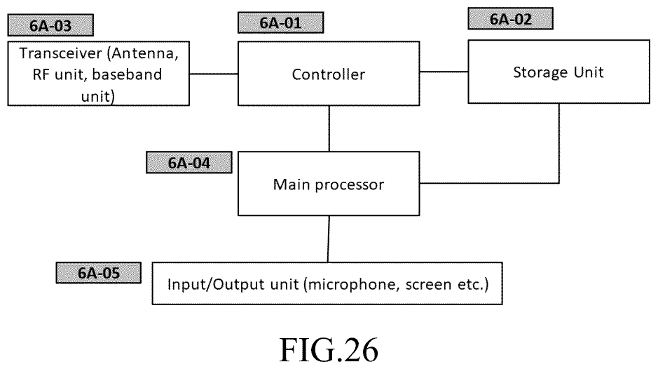

FIG. 26 is a block diagram illustrating the internal structure of a Terminal to which the disclosure is applied.

Referring to the diagram, the terminal includes a controller (6A-01), a storage unit (6A-02), a transceiver (6A-03), a main processor (6A-04) and I/O unit (6A-05).

The controller (6A-01) controls the overall operations of the terminal in terms of mobile communication. For example, the controller (6A-01) receives/transmits signals through the transceiver (6A-03). In addition, the controller (6A-01) records and reads data in the storage unit (6A-02). To this end, the controller (6A-01) includes at least one processor. For example, the controller (6A-01) may include a communication processor (CP) that performs control for communication and an application processor (AP) that controls the upper layer, such as an application program. The controller controls storage unit and transceiver such that UE operations illustrated in the disclosure are performed.

The storage unit (6A-02) stores data for operation of the terminal, such as a basic program, an application program, and configuration information. The storage unit (6A-02) provides stored data at a request of the controller (6A-01).

The transceiver (6A-03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (6A-04) controls the overall operations other than mobile operation. The main processor (6A-04) process user input received from I/O unit (6A-05), stores data in the storage unit (6A-02), controls the controller (6A-01) for required mobile communication operations and forward user data to I/O unit (6A-05).

I/O unit (6A-05) consists of equipment for inputting user data and for outputting user data such as a microphone and a screen. I/O unit (6A-05) performs inputting and outputting user data based on the main processor's instruction.

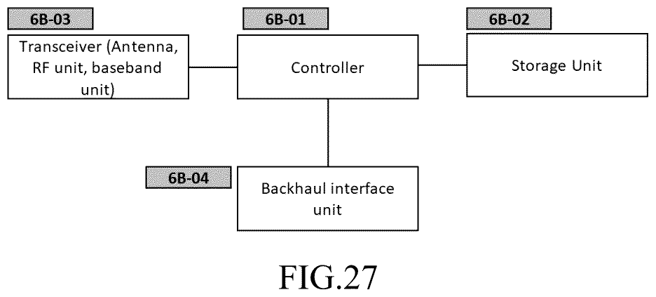

FIG. 27 is a block diagram illustrating the configuration of a base station according to the disclosure.

As illustrated in the diagram, the base station includes a controller (6B-01), a storage unit (6B-02), a transceiver (6B-03) and a backhaul interface unit (6B-04).

The controller (6B-01) controls the overall operations of the main base station. For example, the controller (6B-01) receives/transmits signals through the transceiver (6B-03), or through the backhaul interface unit (6B-04). In addition, the controller (6B-01) records and reads data in the storage unit (6B-02). To this end, the controller (6B-01) may include at least one processor. The controller controls transceiver, storage unit and backhaul interface such that base station operation illustrated in the disclosure are performed.

The storage unit (6B-02) stores data for operation of the main base station, such as a basic program, an application program, and configuration information. Particularly, the storage unit (6B-02) may store information regarding a bearer allocated to an accessed UE, a measurement result reported from the accessed UE, and the like. In addition, the storage unit (6B-02) may store information serving as a criterion to determine whether to provide the terminal with multi-connection or to discontinue the same. In addition, the storage unit (6B-02) provides stored data at a request of the controller (6B-01).

The transceiver (6B-03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (6B-04) provides an interface for communicating with other nodes inside the network. The backhaul interface unit (6B-04) converts a bit string transmitted from the base station to another node, for example, another base station or a core network, into a physical signal, and converts a physical signal received from the other node into a bit string.

Below table lists acronym used in the present invention.

| Acronym | Full name |
|---|---|
| 5GC | 5 G Core Network |
| ACK | Acknowledgement |
| AM | Acknowledged Mode |
| AMF | Access and Mobility |
| | Management Function |
| ARQ | Automatic Repeat Request |
| AS | Access Stratum |
| ASN.1 | Abstract Syntax Notation One |
| BSR | Buffer Status Report |
| BWP | Bandwidth Part |
| CA | Carrier Aggregation |
| CAG | Closed Access Group |
| CG | Cell Group |
| C-RNTI | Cell RNTI |
| CSI | Channel State Information |
| DCI | Downlink Control |
| | Information |
| DRB | (user) Data Radio Bearer |
| DTX | Discontinuous Reception |
| HARQ | Hybrid Automatic Repeat |
| | Request |
| IE | Information element |
| LCG | Logical Channel Group |
| MAC | Medium Access Control |
| MIB | Master Information Block |
| NAS | Non-Access Stratum |
| NG-RAN | NG Radio Access Network |
| NR | NR Radio Access |
| PBR | Prioritised Bit Rate |
| PCell | Primary Cell |
| PCI | Physical Cell Identifier |
| PDCCH | Physical Downlink Control |
| | Channel |
| PDCP | Packet Data Convergence |
| | Protocol |
| PDSCH | Physical Downlink Shared |
| | Channel |
| PDU | Protocol Data Unit |
| PHR | Power Headroom Report |
| PLMN | Public Land Mobile Network |
| PRACH | Physical Random Access |
| | Channel |
| PRB | Physical Resource Block |
| PSS | Primary Synchronisation |
| | Signal |
| PUCCH | Physical Uplink Control |
| | Channel |
| PUSCH | Physical Uplink Shared |
| | Channel |
| DL-AoD | Downlink Angle-of- |
| | Departure |
| GNSS | Global Navigation Satellite |
| | System |
| RACH | Random Access Channel |
| RAN | Radio Access Network |
| RAR | Random Access Response |
| RA-RNTI | Random Access RNTI |
| RAT | Radio Access Technology |
| RB | Radio Bearer |
| RLC | Radio Link Control |
| RNA | RAN-based Notification Area |
| RNAU | RAN-based Notification Area |
| | Update |
| RNTI | Radio Network Temporary |
| | Identifier |
| RRC | Radio Resource Control |
| RRM | Radio Resource Management |
| RSRP | Reference Signal Received |
| | Power |
| RSRQ | Reference Signal Received |
| | Quality |
| RSSI | Received Signal Strength |
| | Indicator |
| SCell | Secondary Cell |
| SCS | Subcarrier Spacing |
| SDAP | Service Data Adaptation |
| | Protocol |
| SDU | Service Data Unit |
| SFN | System Frame Number |
| S-GW | Serving Gateway |
| SI | System Information |
| SIB | System Information Block |
| SpCell | Special Cell |
| SRB | Signalling Radio Bearer |
| SRS | Sounding Reference Signal |
| SS | Search Space |
| SSB | SS/PBCH block |
| SSS | Secondary Synchronisation |
| | Signal |
| SUL | Supplementary Uplink |
| TM | Transparent Mode |
| UCI | Uplink Control Information |
| UE | User Equipment |
| UM | Unacknowledged Mode |
| CRP | Cell Reselection Priority |
| FPP | First positioning protocol |
| SPP | Second positioning protocol |
| DL-PRS | Downlink-Positioning |
| | Reference Signal |
| SL-PRS | Sidelink-Positioning |
| | Reference Signal |

What is claimed is:

1. A method by a terminal, the method comprising:
receiving from a base station a Radio Resource Control (RRC) message, wherein the RRC message comprises:
a parameter indicating a remaining time threshold related to a radio bearer; and
a parameter indicating a maximum retransmission number for a Radio Link Control (RLC) entity that is associated with the radio bearer; and
performing retransmission of a specific RLC Service Data Unit (SDU) in case that:
at least one byte of the specific RLC SDU has been transmitted; and
remaining time of a Packet Data Convergence Protocol (PDCP) SDU associated with the specific RLC SDU becomes less than the remaining time threshold.

2. The method of claim 1,
wherein, to perform the retransmission of the specific RLC SDU, the terminal:
segments the specific RLC SDU according to a total size of Acknowledged Mode Data (AMD) Protocol Data Unit (PDU) at a next transmission opportunity;
maps segment of the specific RLC SDU into a first field of a AMD PDU;
modifies a second field of the AMD PDU, wherein the second field comprises a polling bit; and
transmits the AMD PDU.

3. The method of claim 1,
wherein the specific RLC SDU associated with the PDCP SDU comprises a specific number of specific bytes computed from the PDCP SDU and an authentication code.

4. The method of claim 3,
wherein the authentication code is computed from the PDCP SDU and one or more fields associated with the PDCP SDU.

5. The method of claim 4,
wherein the specific number is equal to sum of size of the PDCP SDU and size of the authentication code.

6. The method of claim 5,
wherein the specific RLC SDU consists of the one or more fields and the specific number of specific bytes.

7. The method of claim 6, wherein:
the specific number of specific bytes comprises a first part and a second part;
the first part corresponds to the PDCP SDU; and
the second part corresponds to the authentication code.

8. The method of claim 1, wherein:
the remaining time of the PDCP SDU is determined based on current value of a discard timer of the PDCP SDU;
the discard timer of the PDCP SDU is initially set to a specific value indicated by the RRC message; and
the discard timer of the PDCP SDU starts when the PDCP SDU is available in PDCP layer.

9. The method of claim 1, wherein:
the terminal sets a retransmission counter of the specific RLC SDU to zero in case that the specific RLC SDU is considered for retransmission first time; and
the terminal determines whether to increment the retransmission counter or not based on whether the specific RLC SDU is considered for retransmission based on the remaining time of the PDCP SDU associated with the specific RLC SDU.

10. The method of claim 9,
wherein the terminal performs cell selection in case that:
the retransmission counter increments based on negative acknowledgement; and
the retransmission counter is equal to the maximum retransmission number.

11. The method of claim 9,
wherein the terminal does not perform cell selection in case that retransmission is considered due to the remaining time.

12. A terminal in a wireless communication system, the terminal comprises:
a transceiver configured to transmit and receive a signal; and
a controller configured to control the transceiver to:
receive from a base station a Radio Resource Control (RRC) message, wherein the RRC message comprises:
a parameter indicating a remaining time threshold related to a radio bearer; and
a parameter indicating a maximum retransmission number for a Radio Link Control (RLC) entity that is associated with the radio bearer, and
perform retransmission of a specific RLC Service Data Unit (SDU) in case that:
at least one byte of the specific RLC SDU has been transmitted; and
remaining time of a Packet Data Convergence Protocol (PDCP) SDU associated with the specific RLC SDU becomes less than the remaining time threshold.
